(19) United States
(12) Patent Application Publication
(10) Pub. No.: US 2025/0344070 A1
(43) Pub. Date: Nov. 6, 2025

(54) LOCATING SHAREABLE ACCESSORIES

(71) Applicant: Apple Inc., Cupertino, CA (US)

(72) Inventors: Siva Ganesh Movva, San Jose, CA (US); Emmanuel Lalande, Montreal (CA); Katherine K. Ernst, San Francisco, CA (US); Kerry Nguyen, Huntington Beach, CA (US); Mariia Holubieva, Cupertino, CA (US); Michael C. Laster, Santa Clara, CA (US)

(73) Assignee: Apple Inc., Cupertino, CA (US)

(21) Appl. No.: 19/199,230

(22) Filed: May 5, 2025

Related U.S. Application Data
(60) Provisional application No. 63/643,381, filed on May 6, 2024.

(51) Int. Cl. H04W 12/63; G06F 9/54; H04L 9/40

(52) U.S. Cl. CPC H04W 12/63; G06F 9/546; H04L 63/0428

(57) ABSTRACT

An electronic user device may detect an accessory device. An onboarding process of the accessory device initiates pairing of the accessory device to the user identifier (ID) associated with the electronic user device. The electronic device may determine whether the accessory device is locked with the user ID or locked with a different user ID and may apply an appropriate procedure in response.

### CROSS-REFERENCES TO OTHER APPLICATIONS

This application claims priority to U.S. Provisional Application No. 63/643,381, for “LOCATING SHAREABLE ACCESSORIES” filed on May 6, 2024, which is herein incorporated by reference in their entirety for all purposes.

### BACKGROUND

Location-tracking applications are designed to help users locate physical objects and other electronic devices. These applications leverage technologies such as global satellite positioning (GPS), Wi-Fi, Bluetooth, and cellular networks to determine the real-time location of the object.

Certain location-tracking applications may allow users to find lost or misplaced devices, e.g., smartphones, tablets, laptops, and smartwatches. Users can trigger an audible alarm or view the device's last known location on a map. Some applications extend beyond devices to track physical items like keys, wallets, or bags. Users attach small Bluetooth-enabled tags to these items, and the application helps locate them.

### BRIEF DESCRIPTION OF THE DRAWINGS

FIG. 1 illustrates a finding environment in accordance with some embodiments.

FIG. 2 illustrates examples of a system architecture in accordance with some embodiments.

FIG. 3 illustrates a flow diagram in accordance with some embodiments.

FIG. 4 illustrates a flow diagram in accordance with some embodiments.

FIG. 5 illustrates an example of a multi-device event data structure in accordance with some embodiments.

FIG. 6 illustrates a flow diagram in accordance with some embodiments.

FIG. 7 illustrates a flow diagram in accordance with some embodiments.

FIG. 8 illustrates a flow diagram in accordance with some embodiments.

FIG. 9 illustrates a flow diagram in accordance with some embodiments.

FIG. 10 illustrates a flow diagram in accordance with some embodiments.

FIG. 11 illustrates a flow diagram in accordance with some embodiments.

FIG. 12 illustrates a flow diagram in accordance with some embodiments.

FIG. 13 is a block diagram of an example device according to the embodiments of the present disclosure.

### DETAILED DESCRIPTION OF THE INVENTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

### I. OVERVIEW

A finding application generally collects location data from various sources, e.g., GPS, Wi-Fi, cellular towers, and Bluetooth beacons, and periodically updates the device's position. The application communicates with a central server to store and retrieve location data. This server manages user accounts, permissions, and data synchronization. The application sends notifications, e.g., alerts such as geofence triggers, to the user's device. To prevent unauthorized access, location data is encrypted during transmission and storage.

### A. Onboarding

Consider an example where a user purchases a new stylus and physically attaches it or wirelessly connects it to a tablet. Physically attaching the stylus to the tablet may include attaching the stylus to connectors (e.g., magnetic connectors) on the tablet. In some instances physically attaching the stylus may include connecting the stylus to the tablet via a wired connection. Wirelessly connecting the stylus to the tablet may include establishing a wireless connection such as a Bluetooth or WiFi connection between the stylus and the tablet. Physical attachment or wireless connection may allow the tablet to exchange information with the stylus.

As part of the out-of-the-box experience, a finding process is opened as an onboarding process to add the stylus to the list of findable devices (e.g., a list of devices, objects, and the like whose geolocations may be determined using a finding application). The process of adding a new accessory device to the list of findable devices may be referred to as pairing the accessory device, e.g., the stylus, with a user identifier (ID) associated with a user (e.g., owner) of the electronic user device, e.g., the tablet. Once the accessory device is paired, the accessor device is said to be locked to the user identifier (ID). When the stylus is paired with the user ID, a finding application on a device (e.g., phone, tablet, etc.) may start a finding session to obtain the location of the stylus. In addition, the authorized devices or user IDs, e.g., authorized family members, may use finding applications on devices associated with their own user ID and find the location of the stylus. As used herein, other types of “pairing” between an accessory device and a user device, for example, Bluetooth pairing, will be described with a term like “Bluetooth pairing” or “network pairing” to distinguish between pairing for the purposes of finding the accessory device.

In some instances, being “locked” is a status associated with a findable device at the computer server. The computer server may store information indicating whether a findable device is locked. If the status of a findable device is locked, it may indicate that it is paired with a user ID. In addition, the computer server may store information of the user ID to which the findable device is locked.

Pairing the stylus with the user ID may include exchanging cryptographic keys between the tablet and the stylus. The cryptographic keys may be used for authentication, attestation, or encryption of information. When the stylus pairs with the user ID or the tablet, a pairing ID may be associated with the pairing between the user ID and the accessory device.

As part of onboarding, the finding process can check whether the stylus is already locked to another user ID. The finding process, e.g., a finding app or daemon, may read device information available on the stylus. For example, the finding process on the tablet may connect with a device information service and read the device information, e.g., a device identifier, such as a serial number, from the stylus. Using the device identifier, the tablet may fetch certain information about the stylus from a computer server associated with the finding process. For example, the information obtained from the computer server may include that the stylus is locked to a user ID that is different from the user ID associated with the tablet. In this case, a notification may display on the tablet indicating that the stylus belongs to someone else and cannot be added to the finding application. If information from the computer server indicates that the stylus is not locked to another user, e.g., another user ID, then a notification may be presented on the tablet's display providing the option to the user to add the stylus to the finding application and pair the stylus with the user ID associated with the finding process or tablet.

When the user selects to add the stylus to the finding application and pairs it to the user ID associated with the finding process, the finding process creates a connection with the stylus and exchanges information, including cryptographic information. The finding process generates an attestation (or a validation) based on the cryptographic information exchanged between the table and the stylus and sends the attestation to the computer server. Once the computer server cryptographically verifies the attestation and finds it genuine, the computer server may associate the stylus with the user ID associated with the finding application, lock the stylus to the user ID, and register the user ID as the owner of the stylus device. Only the owner can remove the lock before giving it to someone else, and only the owner can access and view the stylus on the finding app.

In some embodiments, the owner may pair the stylus on a first tablet. Later, the owner may physically attach or wirelessly connect the stylus to a second tablet, where the first and second tablets are associated with the same user ID. Based on its local information (pre-existing information obtained from the computer server or self-generated information based on information received from the stylus), the second tablet may determine whether the stylus is locked (e.g., paired) or unlocked (e.g., not paired). For example, the finding application or process on the second tablet may obtain information on the paired devices (e.g., the stylus) associated with the owner's user ID from the computer server. The information may include device IDs, such as an ID associated with the pairing of the tablet and stylus or the serial number of the stylus.

In some instances, authorized family member users may access and view the stylus on their finding applications. Using a multi-device sync procedure, devices associated with a finding application, e.g., devices that are associated with the same user ID or devices that are associated with a different user ID but are added to the finding application as family, friends or trusted devices, may access the information of paired accessories or devices. For example, information of a paired accessory, e.g., the stylus, such as location information, connectivity information, or device information, is stored on one or more computer servers or encrypted data stores, and the stored information is synchronized among all devices associated with the finding application. The encrypted data store may be end-to-end encrypted and only accessible by the user associated with the user ID.

### B. Event Data Model

The tablet may receive signals from different devices, some from devices that are wirelessly connected or physically attached to the tablet, e.g., the stylus, and some from other devices, e.g., advertisement packets of other devices. Tablet may generate a data structure for each received signal. The data structure may include location information, source information, device information, motion context information, or attachment information. The information may indicate the time that the signal was detected, the last time the signal from the same source was detected, and the location of the tablet when the signal was received. The information may indicate information to identify the source of the signal, e.g., medium access control (MAC) address or unique universal identifier (UUID). The information may indicate whether the source of the signal was physically attached to the tablet.

The tablet may store the data structure as a data record in the computer server. The tablet may receive one or more data records from the computer server. The tablet may use local information or the received data records to determine the state (e.g., wirelessly connected or physically attached) or location of findable devices.

### C. Last Known Location

Once the stylus is onboarded (e.g., paired), it can be seen in the finding application. In addition to its location, the finding application may also indicate which device the stylus is connected to and whether it is physically attached or wirelessly connected to that device.

Assume that the stylus is paired with a user's tablet and is physically attached or wirelessly connected to it. When the user launches the finding application on a different device (e.g., a phone) using the same user ID, the phone can show the stylus in the list of paired devices. In addition, the finding application on the phone may also indicate that the stylus is physically attached to the tablet. The finding application may also provide timing information of the last update to the location of the stylus. For example, the finding application on the phone may indicate that the stylus was physically attached to the tablet two hours ago. The finding application, in addition, may also provide information on whether the tablet is still functioning or not. For example, if the stylus was attached to the tablet, and the tablet is now offline, the user may use the finding application on their phone to make the stylus findable. The stylus may be findable when it transmits wireless signals that are detectable by the phone, and the phone can use those signals to find the location of the stylus through operations such as proximity finding. The location of the stylus may be the same as the location of the tablet.

In some instances, the tablet periodically provides its location to the computer server. The periodic communication between the tablet and the computer server may be referred to as a heartbeat or pulse. The computer server may identify that the tablet is offline if it does not detect a pulse or receive periodic communication with an updated location.

The above information is stored on an end-to-end encrypted server. The location, timing, and connectivity information described above are available for finding applications and devices associated with the user ID. In some embodiments, authorized users, e.g., family members or friends, may access this information. The owner and authorized family members may generate the encrypted location, timing, or connectivity information described above and store it in the user-encrypted data store.

In some embodiments, a user device (e.g., the tablet) may receive signals from other devices. The user device may generate a data structure associated with the received signal and store it in the computer server. The data structure may include event information. The event information may include source, location, motion context, or attachment information.

In some instances, the received signal may be associated with another device, and the user's device receiving it may not be the intended recipient of the signal. The user device may overhear the signal (e.g., an advertisement signal) and extract information about the sender.

In some embodiments, the user device (e.g., the tablet) may receive one or more data structures associated with another device (e.g., the stylus) from the computer server. Using the precedent, importance, or priority of information in the data structure, the tablet may determine the status of the stylus, e.g., whether it is physically attached or wirelessly connected to a device. It may also identify the device to which the stylus is physically attached or wirelessly connected.

### D. Lost Mode

When the user, e.g., the owner, loses the stylus, the user may use the finding application to mark the stylus as lost. When they do that, they may add their phone number or email address to a “lost message.” Another user, the finder, may find the stylus and physically attach or wirelessly connect it to their tablet. The tablet may recognize that it is a new stylus and may initiate an onboarding process as described above.

The onboarding process may indicate that the stylus is locked to another user ID. The computer server may also send the lost message to be displayed on the tablet. The finder's tablet will read the cryptographic information of the stylus and send it to the computer server. Once the computer server verifies the physical possession of the stylus by the finder, it will send the lost message to the finder's tablet. Sending the cryptographic information to the computer server may be an indication of physical possession. In some instances, the lost message is a generic message generated by the server indicating that the accessory device is lost.

In another flow, consider that a finder finds the stylus and physically attaches or wirelessly connects it to their tablet while the owner of the stylus has not marked it as lost. When the finder's tablet goes through the onboarding flow, the tablet will receive information that the stylus is locked to another user ID. If, after that, the owner marks the stylus as lost, the next time that the finder attaches the stylus, they will know that it is not their device. In addition, the tablet will receive the information indicating that the stylus is marked as lost and may receive the encrypted owner's lost message, e.g., including the owner's contact information, such as phone number or email address. In some examples, even when the accessory device is not connected to the finder's device, the finder's device may periodically send an inquiry to the server for a potential lost message from the owner.

In some instances, once the finder's tablet receives information that the stylus is locked to another user ID, the tablet may be configured to periodically check the computer server for lost mode indication or lost messages associated with the stylus. Periodically sending the cryptographic information (also known as cryptographic payload) of the stylus to the computer server to check for an indication of lost mode could be expensive with respect to power consumption or computation. Instead of cryptographic information, the tablet may use the stylus' serial number to check the computer server for a lost mode indication associated with the stylus. Once the tablet receives a positive response that there is a lost mode associated with the stylus, the tablet may send the cryptographic information to the server as proof of physical possession to receive the lost message from the computer server. The server may also apply a rate limit, e.g., using a counter, to limit the number of attempts to obtain the encrypted lost message. In some instances, a finding daemon on the tablet may initiate a periodic check of the server for a lost mode indication.

When the owner marks the stylus as lost or at a later time, they may provide one or more cryptographic keys to the computer server. Once the computer server receives the cryptographic information of the stylus and verifies the physical possession, the computer server may send one or more of the cryptographic keys provided by the owner to the finder's tablet. The finder's tablet can use the keys to encrypt its location, send it back to the computer server, and make it available to the owner. In some examples, the finder may use the finder's tablet to consent to share the finder's tablet's location with the owner and indicate their consent to the computer server. For example, as part of the lost mode notification displayed on the finder's tablet, a consent form may be displayed to solicit the finder's consent and approval to share their location with the owner of the stylus. In some examples, the finder may provide consent in a setting of the finder's tablet so that the location of the finder's tablet is encrypted and shared to the owner via the computer server without a separate prompt for consent.

In some examples, when the stylus is wirelessly connected or physically attached to the finder's tablet, e.g., a non-owner device, the stylus may constantly send Bluetooth advertisement signals to make itself findable to the owner via Bluetooth proximity finding. Constantly sending advertisement signals may cause a degradation in the finder's user experience when using the stylus. For example, when the stylus attaches to the finder's tablet, the stylus may receive device or pairing information, e.g., a pairing ID, from the tablet. Using the pairing ID, the stylus may determine whether it is paired with the tablet. In some instances, when determining that it is not paired with the tablet, the stylus may enter a fast advertising mode in which it frequently and rapidly sends advertisement packets, e.g., Bluetooth advertisement packets.

In some embodiments, the owner of the stylus may declare the stylus as being lost and change its status on the computer server to indicate that the stylus is lost. The owner may provide a lost message on the computer server. The finder may return the stylus, or the owner may find the stylus. When the owner physically attaches or wirelessly connects the stylus to a tablet associated with the owner's user ID (e.g., the user ID to which the stylus is paired), the computer server may determine that the stylus is attached (e.g., physically attached or wirelessly connected) with a paired device and may suppress sending the lost message. In some embodiments, the network may notify the tablet (or another device associated with the same user ID) to suggest removing or deactivating the lost message.

In some embodiments, when the stylus is physically attached or wirelessly connected to the finder's tablet (whether the stylus is declared lost or undeclared), the finder's tablet may send location information to the computer server. In some instances, the location information may be encrypted. For example, the tablet may encrypt the location information with encryption keys. In another example, the tablet may use encryption keys provided by the owner of the stylus.

In some embodiments, when the stylus is physically attached or wirelessly connected to the finder's tablet, the tablet sends a findable ID to the stylus. The stylus may compare the received findable ID with a findable ID locally stored and determine whether the stylus is paired with the tablet or not. If the stylus determines that it is not paired with the tablet, the stylus may make itself findable, e.g., via proximity finding, by transitioning to a fast advertising mode. In a fast advertising mode, the stylus may send packets (e.g., Bluetooth advertisement packets) that can be used by the owner's device to find and locate the stylus.

Although the above description refers to a stylus as a particular accessory device that can be physically attached or wirelessly connected to a finder's tablet, the “lost mode” processes can be applied to other accessory devices that can connect to the finder's tablet. For example, a headphone or earbud with Bluetooth connectivity can connect to the finder's tablet to initiate the lost mode processes described above.

### E. Family Member's Device

The techniques described herein address a situation in which an authorized/trusted user (e.g., a friend or family member who is part of a predefined list of user IDs) uses an accessory device (e.g., a stylus) with a tablet that is not associated with the owner's user ID. In this situation, because of the predefined trusted relationship between the user IDs, the user experience for interacting with the stylus may be different than the experience described above when a stranger or other unauthorized user finds and begins using the stylus. For example, when the stylus is physically attached or wirelessly connected to an authorized device, e.g., owned by a friend or family member but not a device associated with the owner's user ID, the stylus may not go into advertising mode. As going into fast advertising mode may degrade the performance of the stylus, this possibility is avoided for the authorized user. Similarly, when the finder is an authorized user, the lost mode message may not be displayed on the finder's device. Because the finder's tablet is associated with an authorized user, the owner (via an owner's device) may have access to the tablet's location. In addition, the owner's device may obtain connection information, e.g., whether the stylus is physically attached or wirelessly connected to the authorized tablet.

For example, when the stylus is physically attached or wirelessly connected to an authorized tablet, e.g., a family's authorized tablet, it may receive the owner's findable ID, causing the stylus to determine that it is connected to an owner's device and may not transition into a findable mode, e.g., fast advertising mode.

In some instances, the authorized tablet may put the stylus in findable mode. The authorized tablet may send instructions to the stylus that cause the stylus to transition into a findable mode, e.g., fast advertising mode. For example, a device associated with the user ID that is paired with the stylus may initiate a proximity finding (finding using Bluetooth or wireless signals from the accessory device). The device may request the authorized tablet that is physically attached or wirelessly connected to the stylus to put the stylus in the fast advertising mode. In another example, the authorized tablet may determine (e.g., from information from the computer server) that the device has initiated a proximity finding session to locate the stylus and may instruct the stylus to switch to fast advertising mode.

In some embodiments, the computer server may determine that the stylus is physically attached or wirelessly connected to the authorized tablet and may send a notification to an owner's device indicating that the stylus is physically attached or wirelessly connected to the authorized tablet).

In some instances, the authorized tablet may periodically publish the location of the stylus. In some embodiments, when the owner launches the finding application on a device, the finding application may determine that the stylus has been physically attached or wirelessly connected to the authorized tablet and may send a request to the authorized tablet to update its location or the location of the stylus. The device may use local data records or data records obtained from the computer server to determine the location or state of the stylus when the stylus is physically attached or wirelessly connected to an authorized tablet. In particular, the data records that are generated and stored by the authorized tablet.

### II. System Environment

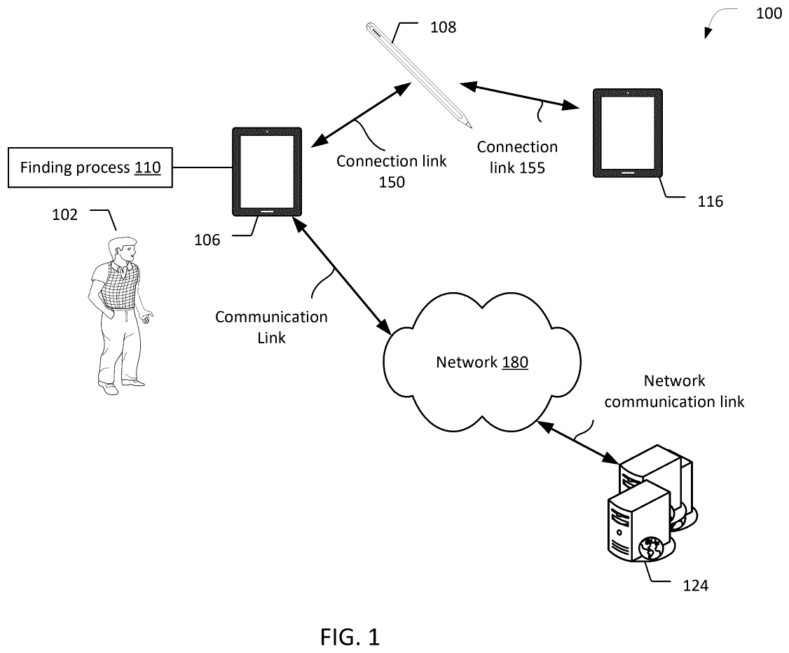

FIG. 1 illustrates a finding environment in accordance with some embodiments. The system environment 100 may include an accessory device 108, e.g., a stylus. Accessory device 108 may be communicatively coupled with electronic user device 106 via connection link 150. The connection link 150 may be a short-range wireless technology such as Bluetooth®, Wi-Fi, NFC, ultra-wideband (UWB), or cellular. Accessory device 108 may be associated with user 102.

Device 106 may be communicatively connected to network 180 via a communication link. The air interface of the communication link may be provided by a cellular technology, such as fifth or sixth-generation wireless, or by wide area networks (WAN) or local area networks (LAN), such as Wi-Fi. Device 106 may be communicatively coupled with server 124 through network 180 and a network communication link.

Server 124 may provide services such as object location services, storage services, application stores, music or video streaming services, or financial services such as online payment. Server 124 may provide a secure and private channel for handling and delivery of messages and notifications between devices. Server 124 may securely transmit data between devices. The resources associated with the server 124, e.g., storage, computation, memory, or connectivity, may be distributed in different geographic locations.

User 102 may be subscribed to services on server 124. User 102 subscription may be associated with a user identification (ID). The user ID may be associated with the user's personal information, such as their name, email address, or payment information. When user 102 sets up a device, e.g., the electronic user device 106 or the accessory device 108, they may use the user ID to register the device on server 124 and to associate it with the user's account, which may allow user 102 to access their personal data and use services provided by server 124 on their devices, e.g., devices 106 or 108. The server 124 may identify a user with their user ID or information associated with their devices, e.g., a phone number. The information associated with a user may be maintained in a user profile on server 124.

In some embodiments, a finding process 110, e.g., a finding application or daemon, may be executed on the electronic user device 106. When accessory device 108 is wirelessly connected or physically attached to electronic user device 106, an onboarding process may be initiated to pair accessory device 108 with the user ID of user 102 or device 106.

As described above, when the accessory device 108 is physically attached, wirelessly connected, or added to an electronic user device 106 (e.g., a computer, phone, iPad) for the first time, an application or a daemon, e.g., finding process 110, on the electronic user device 106 may check if the accessory device 108 is locked to the user ID of another user ID. The electronic user device 106 may send a message to verify whether the accessory device is paired with any other device. The message may be referred to as a paired verification message.

Suppose the accessory device 108 is not locked to another user ID (e.g., not paired with another user ID). In that case, the electronic user device 106 may exchange cryptographic information with the accessory device 108 and share some or all of that information with the computer server 124. The computer server 124 may authenticate the cryptographic information and send a confirmation to the electronic user device 106. Once this occurs, the accessory device 108 is locked to the user ID, e.g., user ID 1.

In some embodiments, the accessory device 108 is locked to the electronic user device 106 (e.g., paired). User 102 may lose the accessory device 108, and another user, a finder, may find the accessory device 108 and physically attach the accessory device 108 (e.g., via a set of corresponding physical interfaces) or wirelessly connect the accessory device (e.g., via a wireless network such as link 155) to electronic user device 116. User 102 may use finding process 110 to declare that the accessory device 108 is lost.

The electronic user device 116 may be associated with another user ID, e.g., user ID 2. When communicatively connected with accessory device 108 (e.g., physically attach or wirelessly connect), the electronic user device 116 may initiate the onboarding process described above. As part of this onboarding process, the electronic user device 116 may attempt to create a pairing connection with the accessory device 108.

In one example, user 102 may declare accessory device 108 lost before electronic user device 116 initiates onboarding to pair with accessory device 108. The electronic user device 116 may send a message to the computer server 124 to inquire about the lock status of the accessory device 108. In response to the inquiry message, computer server 124 may indicate that the accessory device 108 is locked to user ID 1 of user 102.

Computer server 124 may provide a lost message, including the contact information of the user 102 to the electronic user device 116. In some embodiments, the computer server 124 may provide cryptographic keys on behalf of the user 102 to the electronic user device 116. The electronic user device 116 may use the provided keys to encrypt the location information of the electronic user device 116. The electronic user device 116 may store the location information on the computer server 124.

In some embodiments, the user 102 may declare the accessory device 108 lost after the accessory device 108 has been found and attached to electronic user device 116. The first time the accessory device 108 wirelessly connects or physically attaches to electronic user device 116. It will be noted that the accessory device 108 is locked to another user ID, user ID 1, and therefore belongs to another user. The first time the accessory device 108 wirelessly connects or attaches to the electronic user device 116, after the user 102 has declared the accessory device 108 as lost, the electronic user device 116 may receive a lost indication, lost message, or cryptographic keys for sharing the location of the accessory device 108 with the user device 106 for viewing by the user 102.

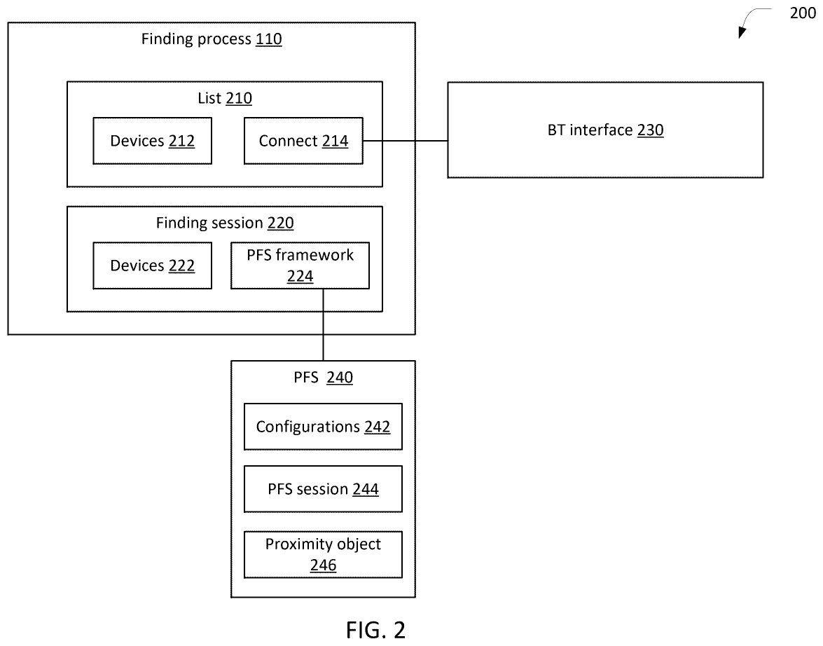

FIG. 2 illustrates examples of a system architecture 200 in accordance with some embodiments. System architecture 200 is a general architecture of finding process 110 and other components providing pairing and finding functionality.

Finding process 110 with components therein collectively may represent finding application framework and daemon. Finding process 110 may use Bluetooth (BT) interface 230 to establish network pairing or Bluetooth pairing. Proximity finding service (PFS) 240 may be responsible for range measurement and locating accessories or other devices using precision proximity positioning.

Finding process 110 may include a list 210 of findable devices 212. When the user launches the finding process 110, the findable devices 212 may be presented. The findable devices 212 may include devices that are associated with the user's user ID and which have been registered with the finding application described herein (e.g., may be located using the finding process 110). The user may select one of the devices 212 with which to connect 214. The connect 214 operations may establish a proximity finding connection with the findable device 212 to obtain its location. The connect 214 operation may use BT interface 230 to establish a network pairing and communicate with the accessory device. When the user selects one of the devices 212 to find, detailed information associated with the selected device may be displayed on the screen of the electronic user device. The information may include the last known location, the device it is connected to, and whether the connected host device is functional or online.

Once a device from the list 210 is selected, connect 214 may establish a connection to BT interface 230 to put the accessory device in a fast advertising mode. Finding session 220 may include and manage finding sessions, each associated with locating an accessory device. Devices 222 includes the list of devices associated with an active finding session. The PFS framework 224 of the finding session 220 manages the performance of precision proximity finding, e.g., setting configurations 242 and establishing PFS session 244.

PFS 240 may include and store configurations 242, including the number of devices being tracked. Precision proximity positioning may be based on cryptographic tokens. PFS session 244 may manage the cryptographic tokens and unique identifiers associated with finding session 220. PFS 240 may also track and manage proximity objects 246.

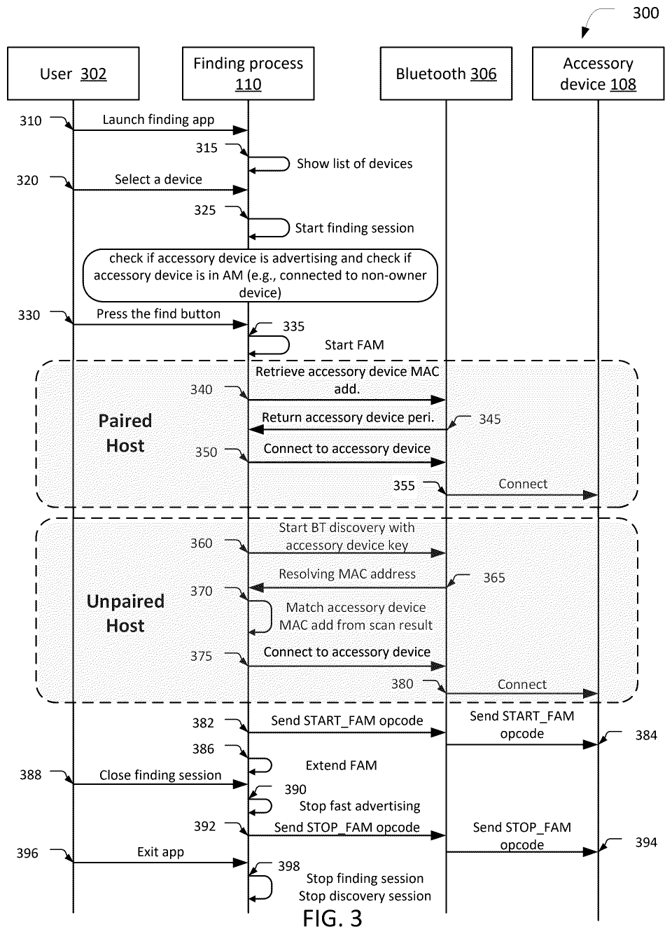

FIGS. 3, 4, 6, 7, 8, 9, 10, 11, and 12 illustrate example flow diagrams showing processes 300, 400, 600, 700, 800, 900, 1000, 1100, and 1200, according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

FIG. 3 illustrates a flow diagram of a process 300 in accordance with some embodiments. The process 300 may be performed or implemented by a user 302, an electronic user device, such as the electronic user device 106, including the finding process 110 and Bluetooth 306, and the accessory device 108.

Paired may refer to associating the accessory device to an account, a user ID, or a device. In some embodiments, when a device (e.g., a tablet or a phone) is associated with a user ID, the device may be findable in a finding application associated with the same user ID. In some embodiments, an accessory device (e.g., a stylus, a speaker, a headphone, an earbud, etc.) may physically attach or wirelessly connect to the device. In some instances, the accessory device may not be explicitly associated with the user ID and may become associated with the user ID through pairing with the device that is explicitly associated with the user ID. In some instances, once an accessory device is paired with a user ID through a device, it may be findable through the finding application on any other device associated with the same user ID. In some instances, the accessory device may be findable on the finding application of devices associated with other user IDs that are authorized by a device associated with the user ID that is associated with the accessory device.

The electronic user device may use a crypto secret that enables the owner device to connect and establish owner authorization to perform any operation on the accessory device as the owner.

Whenever an accessory device is attached to the electronic user device, it generates a new cryptographic key. When an accessory device is paired with the first electronic user device, a cryptographic key is generated and associated with the accessory device. When the accessory device is attached to a second electronic user device, it goes through a second pairing procedure. This means that the first electronic user device has cryptographic key 1, and the second electronic user device has cryptographic key 2. Therefore, the first electronic user device can no longer connect to the accessory device 108 and can no longer find it.

The second electronic user device's cryptographic key may be saved and synchronized across all devices.

In some embodiments, a first electronic user device may be out of range of the accessory device, and a second electronic user device may be in range of the accessory device. The first electronic user device may start a finding session. The second electronic user device may start a proximity-finding session to precisely locate the accessory device and update and sync the location of the accessory device through the encrypted computer server. The second electronic user device may detect and make the information available to the first electronic user device.

Diagram 300 illustrates different scenarios when user 302 lunches a finding application on the electronic user device to find the accessory device 108. The user 302 and the operations and actions initiated by user 302 are performed through the user interface provided by the electronic user device 108. The finding process 110 is the application running on the electronic user device. The Bluetooth (BT) 306 encapsulates the Bluetooth communication and the air interface provided by the BT transceivers at the electronic user device and the accessory device 108. The accessory device 108 represents the processes, e.g., firmware or other operations, that configure and control the operation of the accessory device.

Steps 310-335 describe user 302 initiating a finding session to locate the accessory device 108. Steps 340-355 are related to the scenario and workflow in which the electronic user device (host) is wirelessly paired (e.g., BT paired) with the accessory device 108. Steps 360-380 describe the scenario and workflow in which the electronic user device (host) is not wirelessly paired (e.g., BT paired) with the accessory device 108. For example, the accessory is wirelessly connected or physically attached to a first device associated with a user ID, and the user starts the finding session on a second device associated with the same user ID. The steps in both workflows are intended to establish a findable connection between the electronic user device and the accessory device 108. The findable connection is referred to as a communication link, which may be logical or physical and may include one or more hops, such as intermediary transceivers, that allow the finding process 110 to configure the accessory device 108 or cause the accessory device 108 to operate in a certain way, e.g., fast advertising mode.

Once the findable connection between the finding process 110 and the accessory device 108 is established, the finding process 110 can start, extend, or stop a finding mode, e.g., fast advertising mode, at the accessory device 108. Steps 382-398 show the operations and signal flow that starts, extends, or stops fast advertising mode at the accessory device 108.

Process 300 may include, at 310, launching a finding process 110. For example, user 302 may open the finding application on an electronic user device, e.g., a tablet. The launch of the finding application may be associated with the finding process 110, which may include a finding daemon.

Process 300 may include, at 315, showing a list of paired devices. A graphical user interface of finding process 110 may display a list of findable devices or paired with the user ID associated with the electronic user device or the user 302.

Process 300 may include, at 320, selecting a device. User 302 may select a device to be found using the user interface of the finding process 110. For example, the user may select the accessory device 108 and try to use the finding process 110 to locate the accessory device 108.

Process 300 may include, at 325, starting a finding session. For example, finding process 110 may start a precision proximity discovery session. In precision proximity discovery, the electronic user device 108 may use the wireless signals (e.g., BT advertisement packets) received from the accessory device to find the location of the accessory device with high precision. Finding process 110 checks whether the accessory device 108 is already in findable mode or not. For example, if the accessory device 108 is in advertising mode or fast advertising mode, it is considered to be findable or otherwise discoverable. In some embodiments, when the accessory device 108 is connected to a non-owner device (e.g., a device associated with a user ID that is neither the owner's nor any other authorized user's), the accessory device 108 will become findable and will enter fast advertising mode. In some instances, when accessory device 108 is not in fast advertising mode, the finding process 110 may request accessory device 108 to become findable by getting into a findable mode, e.g., fast advertising mode.

Process 300 may include, at 330, user 302 pressing the find button. User 302 may press the find button, and the finding process 110 may initiate, enabling the findable mode to identify the accessory device 108.

Process 300 may include, at 335, the finding process 110 starting fast advertising mode. Steps 340-355 and 360-380 are steps to send a request, e.g., using Bluetooth connection, to the accessory device 108 to enable the accessory device to go into findable mode, e.g., fast advertising mode. The finding process 110 may determine from local information whether the accessory device 108 is wirelessly connected to the electronic user device. For example, process 110 may check an identifier (e.g., serial number, medium accessory control address, etc.) to be wirelessly connected (or physically attached) to the electronic user device.

Process 300 may describe paired host flow 337 at steps 340-355, including operations for connecting to accessory device 108 when the accessory device 108 is wirelessly connected (e.g., via a BT connection) to the electronic user device. The precision proximity finding may use Bluetooth received signal strength indicator (RSSI) to locate the accessory device 108 with high precision. The finding process 110 may use the wireless connection to access the accessory device 108. The finding process 110 may use the accessory device's 108 information, including MAC address and cryptographic payload, which are updated and stored securely on a computer server to establish the connection between the finding process 110 and the firmware or other processes at the accessory device 108.

Process 300 may include, at 340, retrieving the peripheral of the accessory device's MAC address. Finding process 110 may retrieve the device and connection information of the accessory device from the encrypted computer server. Finding process 110 may obtain a unique accessory device identifier from Bluetooth 306.

At 345, process 300 may include returning the accessory device's peripheral, e.g., a unique identifier. For example, the unique identifier of the accessory device may be its user-unique ID (UUID).

At 350 and 355, process 300 may include establishing a connection between finding process 110 and the accessory device 108 through Bluetooth 306. Finding process 110 may use this connection to send instructions or configuration to the accessory device 108.

Similarly, steps 360-380 describe the unpaired host flow 357 to establish a connection between the electronic user device 106 and the accessory device 108 when the accessory device 108 is paired with a second electronic user device (e.g., a different device than the electronic user device 106). In this example, the second electronic user device and the electronic user device may be associated with the same user ID.

Process 300 may include, at 360, starting Bluetooth discovery with the accessory device's cryptographic key. The finding process may obtain the accessory device's cryptographic key from the computer server. In some instances, the electronic user device may have previously physically attached or wirelessly connected to the accessory device 108 and have obtained and stored the cryptographic key associated with the accessory device 108, e.g., the cryptographic token used for precision proximity finding. The BT 306 may receive the advertisement packets from the accessory device. The electronic user device 106, e.g., the nearby interaction at the second electronic user device, may find an advertisement that matches the cryptographic key of the accessory device 108.

Process 300 may include, at 365, returning scan results resolving the MAC address using the provided cryptographic key. At 370, the scan results may also resolve the MAC address of the accessory device 108. The electronic user device will store information from the accessory device 108, including MAC address and cryptographic payload, which are updated and stored securely on a computer server by the second electronic user device. The second electronic user device that is connected with the accessory device 108 may synchronize and update the accessory device information among all the electronic user devices associated with the electronic user device's user ID.

At 375, the electronic user device 106 may initiate a network connection with the accessory device 108, and at 380, the connection may be completed by BT 306. Once the connection is established, either via the paired host flow 337 or the unpaired host flow 357, steps 382-398 may apply. Steps 382-398 show the operations and signal flow that starts, extends, or stops fast advertising mode at the accessory device 108.

Process 300 may include, at 382 and 384, sending a code to the accessory device 108 via Bluetooth 306 to instruct the accessory device to use fast advertising mode.

Process 300 may include, at 386, extending fast advertising mode for a duration, e.g., every 60 seconds, while the finding session is active. If the accessory device 108 stops fast advertising mode unexpectedly, the finding process 110 will instruct the accessory device 108 to go back into fast advertising mode.

Process 300 may include, at 388, the closing of the finding session. The user 102 may close the finding application on the electronic user device. Upon closing the finding session, process 300 may include, at 390, stopping the fast advertising. Process 300 may include, at 392, sending a message or code to the Bluetooth, a code to be relayed to the accessory device 108 to stop the fast advertising mode.

Process 300 may include, at 394, sending a message or code to the accessory device 108, e.g., the firmware of the accessory device 108, to stop the fast advertising mode.

Process 300 may include, at 396, stopping the finding session and stopping the discovery session, ending or terminating the finding session, and associated fast advertising mode.

In steps 355 or 380, the finding process 110 is connected to the accessory device 108 (e.g., the firmware of the accessory device 108) and may instruct the accessory device to go in a special mode, e.g., finding experience mode, for the purpose of owner finding. For example, the electronic user device may send instructions to the accessory device to cause the accessory device to enter a fast advertising mode.

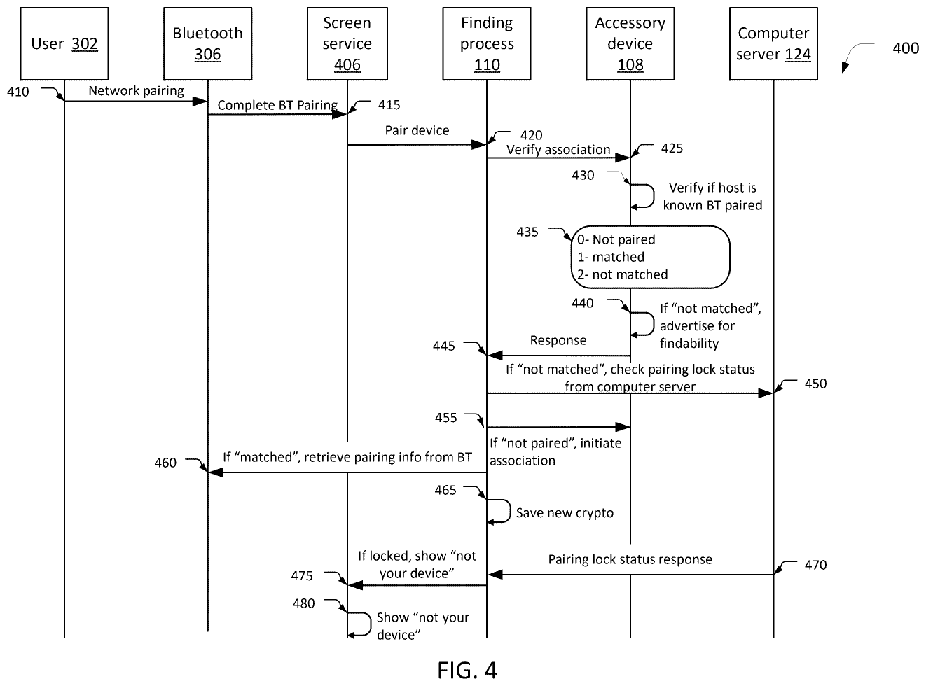

FIG. 4 illustrates a flow diagram for process 400 in accordance with some embodiments. The process 400 may be performed or implemented by an electronic user device, such as the electronic user device 106, 116, or components thereof, such as controller 1300.

Diagram 400 may include separate or different entities. User 302 is associated with the electronic user device and a user ID. The electronic user device includes screen service 406 and finding process 110. The accessory device 108 and the computer server 124. Bluetooth 306 may represent transceivers at the electronic user device and the accessory device 108 and encapsulates the signaling between the two devices. Diagram 400 describes the procedure when an accessory device 108 is detected for the first time by an electronic user device.

Process 400 may include, at 410, establishing a network pairing between the electronic user device and accessory device 108. User 302 may instruct (e.g., by pushing a button) to wirelessly connect the electronic user device with the accessory device 108 (e.g., via Bluetooth 306). Once the network pairing is complete, at 415, a notification may be displayed on the screen indicating that the accessory device 108 is network paired, e.g., Bluetooth paired, with the electronic user device. At 420, the finding process 110 initiates pairing the accessory device 108 with the user ID associated with the electronic user device (or user 302). The finding process 110 may verify whether the accessory device is in the paired state or not.

At 425, process 110 may send a paired verification message to accessory device 108 to request that the accessory device verify the paired state of the accessory device with respect to the electronic user device.

Process 400 may include, at 430, verifying if the connected electronic user device is a known network paired device. Accessory device 108 may periodically check whether the network pairing is active, e.g., the Bluetooth connection is active.

At 435, the accessory device 108 may determine a paired state. The accessory device may receive a pairing ID or other identifiers associated with the finding process 110 or the user ID. The accessory device 108 may compare the received pairing ID with information stored to determine whether accessory device 108 is paired with the user ID associated with the finding process 110 (or the user 302).

In some embodiments, the accessory device 108 may determine that the paired state is “not paired.” The “not paired” state may indicate that the accessory device 108 is not paired with the user ID associated with the finding process 110 and not paired with any other user IDs.

In some embodiments, the accessory device 108 may determine that the paired state is “matched.” The “matched” paired state may indicate that the accessory device 108 is paired with the user ID associated with the finding process 110.

In some embodiments, the accessory device 108 may determine that the paired state is “not matched.” The “not matched” paired state may indicate that the accessory device 108 is paired with a user ID, but the user ID differs from the user ID associated with the finding process 110.

At 440, based on the determination that the paired state is “not matched,” accessory device 108 may start a fast advertising mode to advertise aggressively for owner findability.

At 445, the accessory device 108 may send a response to the finding process 110 of the electronic user device. The response may include the paired state determined by the accessory device 108.

If the pairing state is “not paired,” the finding process 110 may initiate a pairing process, as described by 455. If the pairing state is “matched,” the finding process 110 may update the information at steps 460 and 465.

If the pairing state is “not matched,” finding process 110 may follow steps 450 and 470 to obtain a pairing lock status response. If the pairing lock status indicates that the accessory device is locked, the user is notified in steps 475 and 480. If the pairing lock status indicates that the accessory device 108 is not locked, the same procedure as “not paired” may be followed.

### A. Not-Your-Device Flow

In the “not-your-device” flow, the pairing status indicates that the pairing ID provided in the paired verification message does not match with the information at the accessory device 108.

Process 400 may include, at 450, requesting a pairing lock status from the computer server 124 based on the response from the accessory device 108. The response received from accessory device 108 may indicate that the pairing state is “not matched.” The “not matched” state may indicate that the accessory device 108 may be paired with another user ID and, hence, may be locked to the other user ID. The finding process 110 may request a pairing lock status from the computer server to determine whether the accessory device 108 is associated with another user ID. The request may include device information associated with accessory device 108, e.g., serial number or other identifiers.

At 470, the computer server 124 may provide a lock status response to the finding process 110. The lock status response may indicate whether the accessory device is locked (e.g., paired) to another user ID.

In some embodiments, the lock status may indicate that the accessory device is locked to another user ID. At 475, a notification may be displayed to the user 302. The notification may indicate that the accessory device does not belong to user 302. At 480, a process may keep the notification displaying on the screen.

### B. New-Device Flow

Process 400 may include, at 460, retrieving the latest pairing information from Bluetooth based on the response from the accessory device indicating that the pairing is matched. At 465, the finding process 110 may save the cryptography payload to the association record on the computer server.

Process 400 may include, at 455, initiating onboarding based on the response from the accessory device or the lock status indicating that the accessory is unlocked or not paired with a device.

In some instances, multiple devices may be associated with the same user ID, and “not matched” status may be used when the accessory device is paired with a device that is different from the current device, sending the paired verification message.

### III. Data Structure

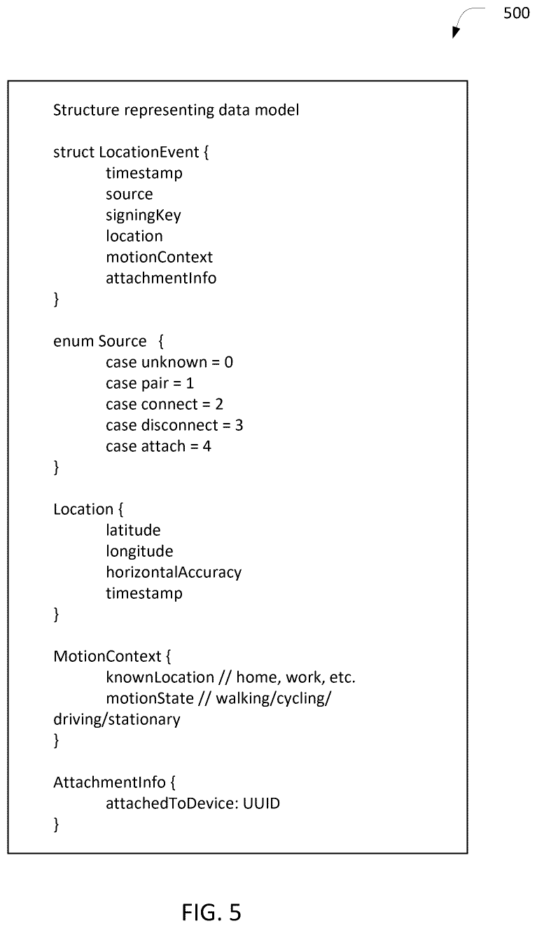

FIG. 5 illustrates an example of multi-device event data structure 500 in accordance with some embodiments. The data structure can be associated with a location event, including, for example, a pairing of an accessory device or other findable device with a user device, connecting and/or disconnecting an accessory device with a user device, or attaching an accessory device with a user device. Information about the location even can include a time stamp, a source, and a signing key for encryption. The data structure may include location or motion information (e.g., walking, running, driving). For example, a location corresponding to the location event can include a position of the accessory device (e.g., latitude and longitude), an accuracy estimate (e.g., horizontal accuracy), and a timestamp, as well as whether the location is a “known location” like home, work, school, or other identifiable location known to the user device. The data structure may include connection information, such as whether the connection is wireless or a physical attachment, pairing information, connect or disconnect information, or attach and detach information.

The connection information can also include information identifying whether the connection was from an “observation” of a signal or beacon from an accessory device, which may not involve a temporary or persistent communication connection between the accessory device or the user device. For example, the user device can receive a location beacon (e.g., Bluetooth beacon) from an accessory device and generate (or update) the data structure 500 with connection information for the location event corresponding to the received beacon.

In some instances, the data structure may include multiple contexts with additional labels, motion states (e.g., walking, cycling, etc.), and connection information. The data structure may include feature compatibility in terms of being able to provide initial information as well as versioning.

In some instances, the connection information may include Bluetooth connection information and other communication connections including, for example, cellular, Wi-Fi, and location beacons. For example, the connection information can identify the specific protocol (e.g., Bluetooth Low Energy) used for the connection corresponding to the connection event.

In some embodiments, a user device may receive signals (e.g., decode the received signal and extract information from the signals) associated with other devices. For example, the user device can receive a signal from a stylus connected to the user device for the purposes of pairing the stylus with the user device according the processes described above with respect to FIG. 4. As another example, the user device can receive an advertisement signal from an accessory device that is operating in an advertisement mode. The user device may generate a data structure 500 associated with the received signal. The data structure 500 may include information related to the source, location, motion, or the other device.

For example, the source information may include information indicating whether the user device was paired, physically attached, or wirelessly connected to the source of the signal, e.g., the other device. The data structure 500 may include information related to the location of the user device when the signal was received. For example, the location information may include the latitude, longitude, horizontal accuracy information, a timestamp, and/or any other suitable information. The motion information may indicate whether the user device was moving (e.g., walking, driving, cycling) or stationary. The location information or the motion information may include information elements indicating whether the user device was in a known location, e.g., home, office, etc. The data structure 500 may include information to identify the source of the signal, including identifying the particular device originating the signal. For example, the data structure can include a user ID or a universal unique identifier (UUID) associated with the source (associated with the device). The data structure 500 may include information such as the time the signal was detected first (beginning of the detection) and was detected last (end of detection) if it was connected, when it was connected and when it was disconnected, or if it was physically attached when it was attached and when it was detached. In some embodiments, the data structure 500 can include source information for the user device generating the data structure 500, including identifying information like a user ID or a UUID for the user device.

In some embodiments, the user device can receive signals from multiple accessory devices and generate the data structure 500 with information from the multiple accessory devices. For example, the data structure 500 can have location event information, source information, location, motion context, attachment information, and/or device identification information for each of the multiple accessory devices. If the user device receives signals from additional accessory devices, the data structure 500 can be updated with the additional information for that additional accessory device. In some embodiments, the user device can generate a data structure 500 for each of the multiple accessory devices from which the user device receives signals.

In some embodiments, the user device can associate the timestamp of detecting the accessory device (e.g., a location event) with a timestamp corresponding to a location of the user device, as shown in data structure 500 of FIG. 5. The user device can use the timestamps stored locally in the data structure 500 to compute the current state of the accessory, for instance whether the accessory is currently connected to the user device (e.g., by wireless Bluetooth signal or by physical attachment). The user device can also use the timestamps in data structure 500 to compute whether the accessory has disconnected, detached, or otherwise changed state with respect to the user device. For example, based on an event timestamp and a subsequent event timestamp, the user device can determine a time and location where an accessory device was disconnected from the user device.

In some embodiments, the information of data structure 500 stored locally, including timestamps and sources of events for accessory devices can also be compared with the timestamps and sources received from the computer server from other reporting user devices. For example, in a finding session the user device can receive additional data structures that include event and location information with timestamps that can be used to determine the current state of the accessory device. The user device in the finding session can use the timestamps to identify events that occurred more recently than other events, as well as determine a time for a change of the state of the accessory device. In addition, the user device can use the timestamp information in conjunction with other elements of the data structure 500, including event precedence (described in more detail below), to determine the state of the accessory device. For example, an accessory device may lose a Bluetooth connection with the user device while remaining physically attached to the user device. The user device can use the information in the data structure 500 to determine that the accessory device remains attached even when a timestamp associated with the attach event is earlier than a timestamp associated with the loss of the Bluetooth connection.

In some examples, the user device can also use an operating system boot session identifier to associate the boot session with the accessory device event and location information in the data structure 500. If the user device is rebooted, the boot session identifier can change. The user device can determine that accessory device events maintained locally (e.g., in data structure 500) may no longer be current based on the changed boot session identifier. The user device can reevaluate the state of the accessory device for the current session to determine whether the accessory device is attached, detached, detected nearby, and the like. The data structure 500 can be updated or a new data structure 500 generated to reflect the new evaluation of the state of the accessory device.

In some embodiments, the user device may encrypt and store the data structure 500 in the computer server. When the user device launches a finding session to locate a findable device (e.g., a paired device or a device of an authorized family member), it may receive one or more data structures associated with the findable device. The user device may determine the status of the findable device, for example, whether the findable device is physically attached or wirelessly connected to another device. The user device may use ranking, priority, precedent, importance, or other attributes associated with information elements of each data structure to identify the status of the findable device. The user device may make the determination locally based on its local information and the received data structures associated with the findable device. For example, since the data structures may be encrypted before being stored at the server device, the user device can decrypt the received data structures associated with the findable device. In this way, the server device may not be able to access the unencrypted information in the data structures (e.g., data structure 500). In some embodiments, the user device may use the data structure of devices other than the findable device to determine the state of the findable device (e.g., whether the findable device is powered on, powered off, wirelessly connected, physically attached, active, dormant, etc.). In some embodiments, the encrypted data structure transmitted to the computer server can be accompanied by additional, unencrypted data associated with the data structure. The additional data can include a timestamp different from location and event timestamps within the data structure. This third timestamp can be used by the computer server to evaluate the validity of the encrypted data structure. For example, the computer server can reject event data structures that are received out of order based on the third timestamp. The additional data can also include information related to the quality of the event data in the data structure and/or the source of the event data in the data structure. The computer server can use the additional data to accept or reject the received data structure information based on criteria. For example, a confidence score can be computed for the data structure by the user device and used by the computer server to determine whether to reject the received data structure information.

As noted above, the data structure 500 may be encrypted before being transmitted to and stored at the computer server. In this way, the computer server and entities associated with the computer server may not be able to access the information (e.g., location information) in the data structure 500. When a user device receives an encrypted data structure 500 from the computer server, the user device may be able to decrypt the data structure 500 using cryptographic information available to the user device. For example, an owner's device may provide a public key of a key pair generated by the owner's device. The public key may be provided to the computer server as part of a lost device message indicating that an accessory device of the owner is lost. When a finder device connects to the lost accessory device and receives a lost indication from the computer server, the finder device can obtain the public key, generate the data structure 500 associated with the connection to the lost accessory device, and use the public key to encrypt the data structure 500. The encrypted data structure 500 can then be transmitted and stored at the computer server and provided to the owner device. The owner device can then decrypt the data structure 500 using the private key of the key pair, thereby allowing only the owner device to obtain the location information associated with the finder device and the lost accessory device.

Each piece of information in the data structure may have precedent over others in obtaining status. For example, an “attach” or “connected” status may have priority or precedent over “detach” or “disconnected.” If a data structure indicates that the user device is attached to the findable device, the information may have precedence over information from a data structure that indicates the user device was detached or disconnected from the findable device. In this way, a user device can determine more relevant location information of the findable device since the findable device was physically attached to a device, rather than just nearby and wirelessly connected to the device.

For example, the user may have a phone and a tablet, and a stylus is wirelessly connected to the tablet. The tablet may generate a data structure indicating that the stylus is wirelessly connected to the tablet and may include the location or other information. When the user launches the finding application on their phone, the phone may retrieve the data structure stored on the computer server and determine that the stylus is wirelessly connected to the tablet. It may provide (e.g., display) information about the last known time or location of the tablet or stylus. The data structure may determine whether the tablet belongs to the user or an authorized user, e.g., a family member.

In some embodiments, when the accessory device is physically attached or wirelessly connected to an authorized device, the finding experience at the accessory device may be disabled, e.g., the accessory device may not make itself findable by going into fast advertising mode. When the user device receives the information from the data structure 500 and determines that the accessory device is connected to an authorized device, the user device may send a request to the authorized device to put the accessory device in the findable mode, e.g., fast advertising mode.

### IV. Methods

### A. Onboarding at the Accessory Device

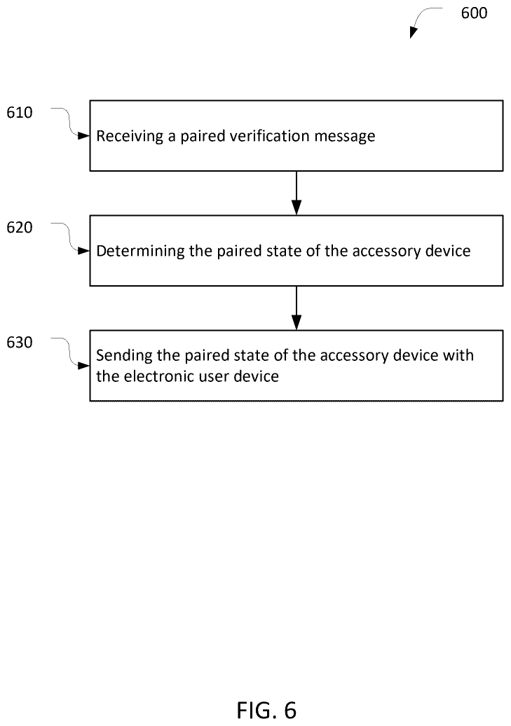

FIG. 6 illustrates a flow diagram of an example process 600 in accordance with some embodiments. Process 600 may be performed or implemented by an accessory device, such as the accessory device 108, or a component thereof, such as controller 1300.

Process 600 includes operations at the accessory device when it is physically attached or wirelessly connected to an electronic user device. Process 600 may correspond to block(s) 425-445 of FIG. 4.

Process 600 may include, at 610, receiving a paired verification message. The accessory device may receive a paired verification message from the electronic user device. The paired verification message may request the accessory device to verify a paired state of the accessory device with respect to the electronic user device. Block 610 may correspond to block(s) 425 of FIG. 4.

In some embodiments, the paired state may indicate that the accessory device is “not matched,” indicating that the accessory device is paired with a user ID but not the user ID associated with the electronic user device. In response to such determination, the accessory device may be configured to advertise a network connection signal, e.g., a fast advertisement signal, e.g., corresponding to block 440 of FIG. 4. The network connection signal may include a medium access control (MAC) address of the accessory device. The network connection signal may include a cryptographic token or cryptography information associated with the accessory device and a user ID or device with which the accessory device is paired.

In some embodiments, the accessory device may determine that the accessory device is “not paired,” indicating that the accessory device is not paired with any user ID, including the user ID associated with the electronic user device. The accessory device may send an indication or a request to the electronic user device to initiate a pairing process, e.g., corresponding to block 445 of FIG. 4.

Process 600 may include, at 620, determining the paired state of the accessory device. Block 620 may correspond to block(s) 430 and 435 of FIG. 4. The accessory device may determine whether it is paired or network paired (e.g., Bluetooth paired or wirelessly paired) with the electronic user device. The accessory device may determine that there is no pairing (for the purposes of finding the accessory device) or network pairing between the accessory device and the electronic user device. The accessory device may receive a pairing ID or other information such as serial numbers or other IDs associated with the electronic user device. The accessory device may use the received information to determine the paired state.

In some instances, in response to determining that the paired state is the first paired state, e.g., “not matched,” the accessory device may switch to a fast advertising mode and cause the accessory device to advertise a network connection signal. For example, based on determining that the accessory device and the electronic user device are not paired, the accessory device may activate fast advertising mode to make itself findable by a new device or device associated with a user ID with which the accessory device is paired, e.g., corresponding to block 440 of FIG. 4.

Process 600 may further include determining, based on the firmware of the accessory device, that the accessory device is paired with a first user identifier (ID) associated with the electronic user device. The accessory device may further determine, based on the paired verification message, that the paired verification message is associated with a second user ID that is different from the first user ID.

In some embodiments, one or more operations of the firmware of the accessory device may determine that the accessory device is paired with a first user ID. The accessory device, e.g., the firmware of the accessory device or some process of the accessory device, may determine a second user ID of the electronic user device. By comparing the first user ID and the second user ID, the accessory device may determine whether the accessory device is paired with the electronic user device.

Process 600 may include, at 630, sending the paired state of the accessory device with the electronic user device. The accessory device will send a message back to the accessory device. The message may include an indication related to the pairing status. For example, the message may indicate that the accessory device is paired with the electronic device, or the message may indicate that the accessory device was previously or currently network paired (e.g., Bluetooth paired) with the electronic device. The message may indicate that the accessory device and electronic user device are not paired.

### B. Onboarding Procedure at the Electronic User Device

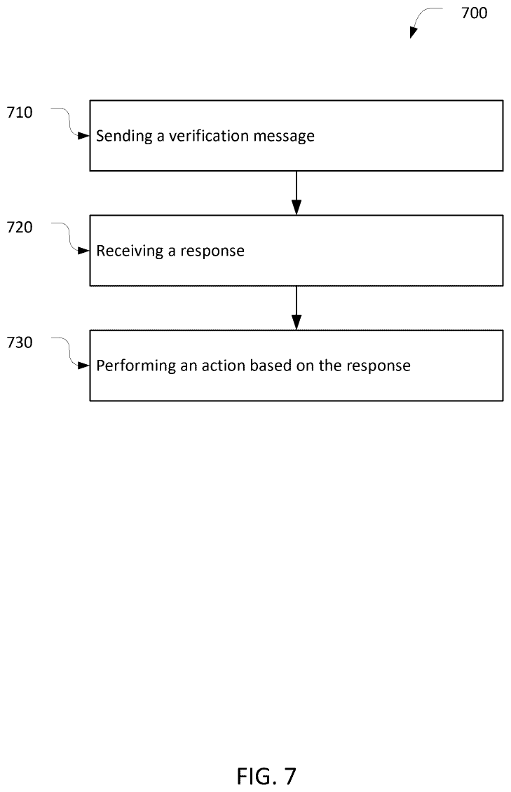

The onboarding procedure may be similar to the flow described in FIG. 4. The onboarding procedure may describe the procedures when an accessory is physically attached or wirelessly connected to an electronic user device. The onboarding procedure in FIG. 7 describes the operations of the accessory device.

FIG. 7 illustrates a flow diagram of an example process 700 in accordance with some embodiments. The process 700 may be performed or implemented by an electronic user device, such as the electronic user device 106, 116, accessory device 108, or components thereof, such as process 110 or controller 1300.

Process 700 may include, at 710, sending a verification message. Block 710 may correspond to block(s) 425 of FIG. 4. The electronic user device may send a paired verification message to the accessory device. The paired verification message may request the accessory device to verify a paired state of the accessory device with respect to the electronic user device. The user device may be associated with a user or a user ID. For example, the electronic user device may use Bluetooth signaling to send the paired verification message to the accessory device. In some instances, the accessory device may be physically attached to the electronic user device. The electronic user device may use the physical attachment and associated interface to send the paired verification message to the accessory device.

Process 700 may include, at 720, receiving a response. Block 720 may correspond to block(s) 445 of FIG. 4. The electronic user device may receive a response from the accessory device. The response may identify a paired state.

For example, the paired state may be one of a plurality of paired states such as “not paired,” “matched,” or “not matched,” e.g., corresponding to block(s) 435 of FIG. 4. In some embodiments, “not paired” may indicate that the accessory is not paired with any user ID, and a pairing procedure may be initiated.

In some embodiments, “matched” may indicate that the accessory device and electronic user device are paired. In some instances, “matched” may also indicate that, additionally or alternatively, the accessory device and the electronic user device are currently or were previously network paired, e.g., physically attached or wirelessly connected.

In some embodiments, “not matched” may indicate that the accessory device and the electronic user device are not paired. It may also indicate that the accessory device is paired with another user device or user ID.

Process 700 may include, at 730, performing an action based on the response. Depending on the paired state, the electronic user device may perform a different action.

In some embodiments, the response may indicate that the accessory device is not paired with the electronic user device. The electronic user device may send a message to a computer server. The message may request a pairing lock status associated with the accessory device from the computer server, e.g., corresponding to block(s) 450 of FIG. 4.

In some embodiments, the response may indicate that the accessory device is paired, e.g., “matched,” with the electronic user device. The electronic user device may determine a network pairing information (e.g., Bluetooth pairing) associated with a network pairing connection (e.g., wireless connection or physical attachment) between the electronic user device and the accessory device, e.g., corresponding to block(s) 460 and 465 of FIG. 4.

In some embodiments, the response may indicate that the accessory device is not paired. The electronic device may initiate a pairing procedure between the accessory device and the electronic user device to pair the accessory device and the electronic user device, or a user ID associated with the electronic user device, e.g., corresponding to block(s) 455 of FIG. 4.

In some embodiments, where the electronic user device requests a pairing lock status from the computer server, the electronic user device may receive a pairing lock status response from the computer server, e.g., corresponding to block(s) 470 of FIG. 4. In some instances, the electronic user device may determine, based on the pairing lock status response, that the accessory device is not paired with the electronic user device or any other device. In this case, the electronic user device may follow the procedure to pair the accessory device with the user ID. In some instances, the pairing lock status response may indicate that the accessory device is locked (e.g., paired) with another device. In this case, a notification may be displayed on the electronic user device indicating that the accessory may belong to another user.

In some embodiments, the pairing lock status response may determine a first user ID to which the accessory device is paired or locked. In some instances, the first user ID may be the same as the user ID associated with the electronic user devices. In some instances, the first user ID may be different from the user ID associated with the electronic user device.

### C. Lost Mode and Undeclared Lost Procedures

During the onboarding procedure described above, e.g., in FIG. 7, the response to the pairing lock status response received from the computer server, the electronic user device may determine that the accessory device is locked or paired with a user ID or device (owner) that is different from the electronic user device or associated user ID. The electronic user device may follow a lost message flow.

In some embodiments, the owner (e.g., the device, the user ID, or the associated user) of the accessory device may determine that the accessory device is lost. The owner may set the status of the accessory device to indicate that the accessory device is lost. For example, using the finding application, the owner may change the status of the accessory device to a state associated with lost devices, e.g., “lost” state.

The owner may leave a lost message along with contact information. When a finder device different from an owner device is physically attached or wirelessly connected to the accessory device, it may receive the lost message.

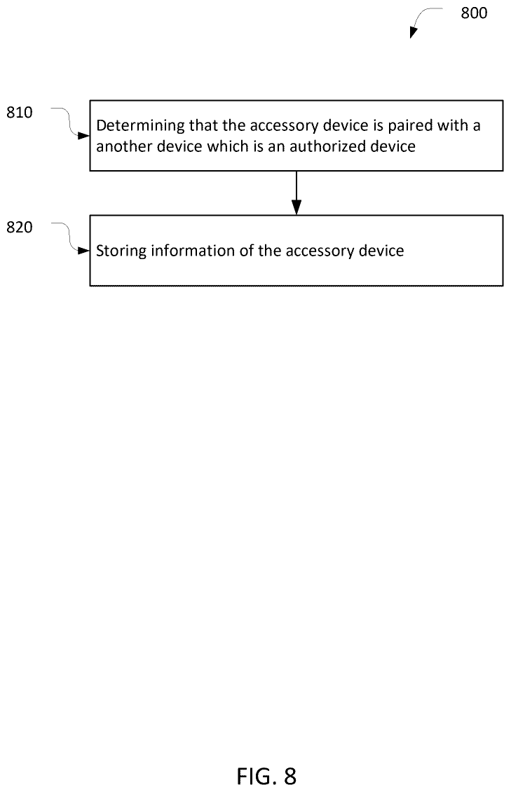

FIG. 8 illustrates a flow diagram of an example process 800 in accordance with some embodiments. The process 800 may be performed or implemented by an electronic user device, such as the electronic user device 106, 116, or components thereof, such as process 110 or controller 1300.

Process 800 may include, at 810, receiving a message. During the initial onboarding and based on accessory device information, the electronic user device may receive an encrypted message from the computer server. The electronic user device may provide the serial number or other device information to the computer server. Other device information may include the cryptographic payload that the electronic user device has obtained from the accessory device.

Process 800 may include, at 820, determining, based on the message, that the accessory device is lost. The electronic user device may send information, e.g., encryption payload or encryption information associated with the accessory device. Providing the encryption payload or encryption information may indicate that the electronic user device has physical possession of the accessory device.

Process 800 may include, at 830, receiving information from the computer server. The information may include a lost message. The lost message may be encrypted and may include personal information associated with the owner of the accessory device. Personal information may include name or contact information (e.g., phone number or email address).

In some embodiments, based on the determination that the accessory device is lost, the electronic user device (e.g., a process or daemon of the electronic user device) may initiate sending periodic requests to the computer server. The request message may inquire about a lost message associated with the accessory device. In some instances, the electronic user device may send periodic requests when the accessory device is physically attached or wirelessly connected to the electronic user device. In other instances, the electronic user device may send periodic requests at all times, e.g., even when the accessory device is not physically attached or wirelessly connected to the electronic user device.

In some embodiments, the information received from the computer server may include one or more encryption keys associated with the owner. The electronic user device may encrypt location information associated with the accessory device using the encryption keys and store it at a location server or computer server.

In some instances, when the electronic user device physically attaches or wirelessly connects to the accessory device, the server may not have a lost message from the owner of the accessory device. After the initial connection or attachment, the owner may set up a lost message on the computer server.

In some embodiments, the electronic user device may be connected to the accessory device after initial onboarding. For example, the electronic user device may physically attach or wirelessly connect to the accessory device. The electronic user device may send a request to the computer server asking whether there is a lost message or other information associated with the accessory device. In some instances, the request may include an identifier associated with the accessory device, e.g., a serial number. In some instances, the request may include cryptography payload or other cryptography information associated with the accessory device. The electronic device may periodically send the request to the computer server. In some embodiments, the electronic device may send the request only when the accessory device is physically attached or wirelessly connected to the electronic device. In other embodiments, the electronic device may send the request even when the accessory device is not physically attached or wirelessly connected to the electronic device.

In some embodiments, the electronic user device may receive an indication of a lost mode associated with the accessory device from the computer server in response to the request (e.g., the periodic request messages). Based on the received indication of the lost mode, the electronic user device may establish an encrypted and secure link to the computer server. The electronic user device may receive an encrypted message that is associated with the accessory device, e.g., the lost message provided by the owner from the computer server and on the encrypted and secured link. The lost message may include the owner's personal information, e.g., name or contact information such as phone number or email address.

### D. Connection or Attachment to Authorized Devices

In this scenario, the accessory device is associated with an owner, e.g., a user ID associated with the owner or a device associated with the owner. The device is physically attached or wirelessly connected to the electronic user device and is not associated with the owner or owner's user ID. However, the electronic user device is authorized by the owner. For example, the electronic user device, or user ID associated with the electronic user device, is paired with the owner user ID or a device associated with the owner ID.

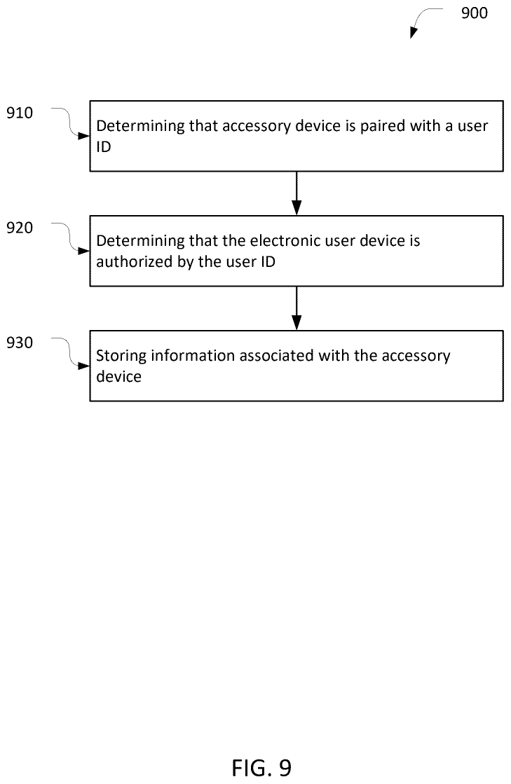

FIG. 9 illustrates a flow diagram of an example process 900 in accordance with some embodiments. The process 900 may be performed or implemented by an electronic user device, such as the electronic user device 106, 116, or components thereof, such as process 110 or controller 1300.

Process 900 may include, at 910, determining that the accessory device is associated with a first user ID. The electronic user device may receive information from the computer server indicating that the accessory device is associated with a user ID, e.g., the owner's user ID. The owner user ID may be different from the user ID of the electronic user device.

In some embodiments, the accessory device may be paired with a first user ID. An electronic user device, which is an authorized device by the first user ID, may be associated with a second user ID. When the electronic user device sends a paired verification message to the accessory device, it may include the first user ID or a pairing ID associated with the first user ID in the message. The accessory device may receive the user ID or the pairing ID and determine that the paired state is “matched,” e.g., the accessory is paired with the electronic device (e.g., the user ID associated with the electronic user device).

Process 900 may include, at 920, determining that the electronic user device is authorized by the user ID. In some embodiments, the electronic user device may determine that it is an authorized device in relationship with the owner's user ID. For example, the electronic user device or the user ID associated with the electronic user device may be paired with the owner's user ID or the user ID of the electronic user device may be authenticated and authorized as a family member associated with the owner's user ID. In another example, the owner may authorize the electronic user device or the user ID associated with it to access the information of the findable devices associated with the owner's user ID, e.g., via authentication, consent, and authorization of location-sharing applications.

Process 900 may include, at 930, storing information associated with the accessory device. The electronic user device may generate data structure, e.g., similar to those described in FIG. 5. The electronic user device may encrypt information associated with the accessory device and store it on the computer server. For example, the electronic user device may encrypt information, including connectivity or accessory device information. In one example, the authorized electronic user device may store the information on an encrypted data store, e.g., a cloud-based storage. The connectivity information may include an indication associated with a physical attachment or a wireless connection between the accessory device and the electronic user device. The device information stored in the encrypted data store may include encryption payload or identifiers such as serial numbers. In some embodiments, the stored information may indicate whether the electronic user device is functional, on standby, sleeping or hibernating, or out of battery, or other indications associated with the operation or battery status of the electronic user device. Similarly, the stored information may indicate the operation or battery status of the accessory device, e.g., whether the accessory device is functional, on standby, sleeping or hibernating, or out of battery.

### E. Pairing and Locking Procedure

In this scenario, the accessory device is not associated with any user ID, and the accessory device and the electronic user device may pair.

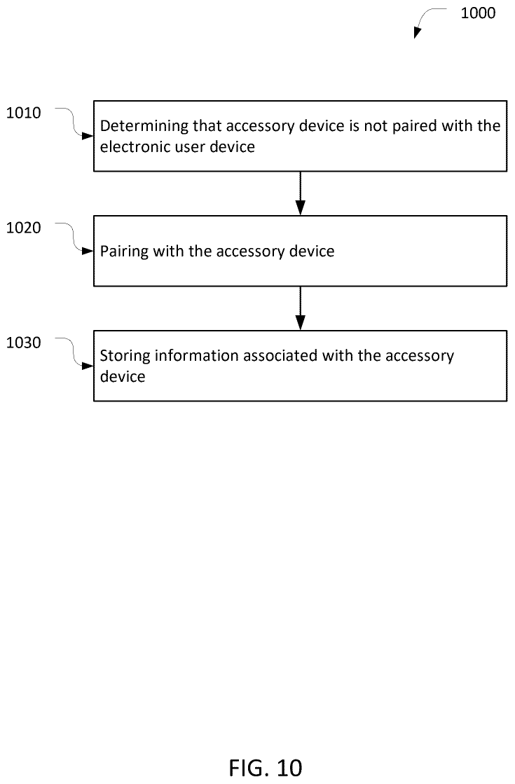

FIG. 10 illustrates a flow diagram of an example process 1000 in accordance with some embodiments. The process 1000 may be performed or implemented by an electronic user device, such as the electronic user device 106, 116, or components thereof, such as process 110 or controller 1300.

In this scenario, the accessory device is not associated with any user ID, and the accessory device and the electronic user device may pair.

Process 1000 may include, at 1010, determining that the accessory device is not paired with the electronic user device. For example, based on the pairing lock status response received from the computer server, the electronic user device may determine that the accessory device is not paired with any user ID.

A user interface may send a notification to the user (e.g., on the screen of the electronic user device) to pair (e.g., adding the accessory device to the finding application) with the accessory device. The user may push a button or make a selection that may generate an indication to initiate a pairing with the accessory device.

A process (e.g., the finding process or application) may receive the indication to initiate a pairing session to pair the accessory device with the electronic user device.

Process 1000 may include, at 1020, pairing with the accessory device.

Process 1000 may include, at 1030, storing information associated with the accessory device. The electronic user device may store information associated with the accessory device in an encrypted data store. The information may include connectivity, device, or location information associated with the accessory device. The information may have a data structure similar to that described in FIG. 5.

In some embodiments, the information may include indications related to battery status or operation of the electronic user device or the accessory device as described above.

### F. Finding Procedures

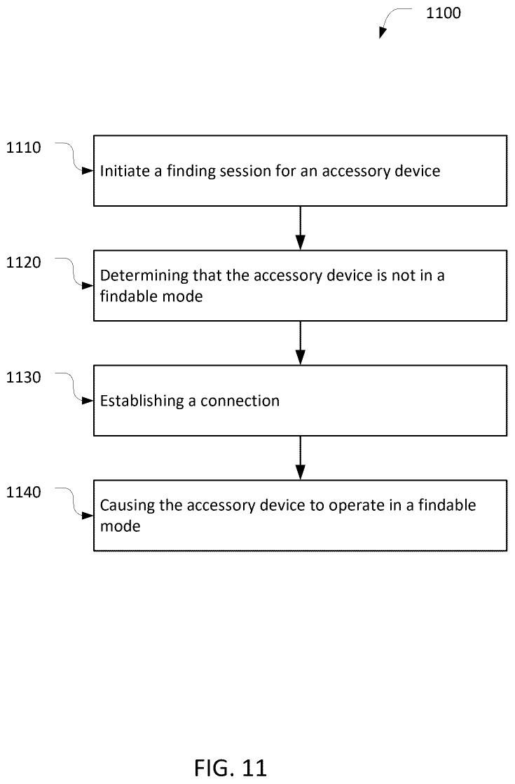

FIG. 11 illustrates a flow diagram of an example process 1100 in accordance with some embodiments. The process 1100 may be performed or implemented by an electronic user device, such as the electronic user device 106, 116, or components thereof, such as process 110 or controller 1300.

In this scenario, the accessory device is associated with a user ID, and the user initiates a discovery or finding session to locate the accessory device. The accessory device may be within the wireless range of the electronic user device, in which case the electronic user device may initiate a proximity-finding procedure. In the proximity-finding procedure, the electronic user device may use the wireless signals received from the accessory device to find its location. For example, the electronic user device may use the Bluetooth advertisement signals the accessory device sends to find its location. The electronic user device may instruct the accessory device to switch to fast advertising mode to assist the electronic user device in the proximity-finding procedure.

In some embodiments, the accessory device may be physically attached or wirelessly connected to a second device different from the first device from which the user has initiated the finding session. Alternatively, the accessory device may be physically attached or wirelessly connected to an authorized device, e.g., a family's authorized device. The first device, used by the user to find the accessory device, may send a request or message to the second device, which is physically attached or wirelessly connected to the accessory device, to put the accessory device in a findable mode, e.g., fast advertising mode.

In some embodiments, the accessory device may be connected to an unknown device, e.g., not a device associated with the user nor an authorized device. For example, the accessory device may be lost and is physically attached or wirelessly connected to a finder's device.

In some embodiments, when the user initiates the finding session on the electronic user device to locate the accessory device, the finding session may receive one or more data structures (e.g., data structures described in FIG. 5). In one example, the electronic user device may send a request to the computer server to obtain the one or more data structures.

In some embodiments, the electronic user device may use one or more data structures and local information to determine a state of the accessory device. The state may indicate whether the accessory device is physically attached or wirelessly connected to another device. The electronic user device may also use the received data structures and local information to determine the device to which the accessory device is physically attached or wirelessly connected.

Process 1100 may include, at 1110, initiating a finding session. The electronic user device may initiate a finding session to find the accessory device. The accessory device is paired with the electronic user device, and the user may initiate the finding session using the finding application on the electronic user device.

Process 1100 may include, at 1120, determining that the accessory device is not in a findable mode. The electronic user device may determine that the accessory device is not in a fast advertising mode. For example, the electronic user device may receive one or more advertisement packets from the accessory device and may determine that the accessory device is not in a fast advertising mode. In some instances, the electronic user device may use local information and one or more data structures to determine whether the accessory device is in a fast advertising mode. In another example, the electronic user device may obtain information from other devices associated with the same user ID as the electronic user device or may obtain information from authorized devices to determine that the accessory device is not in a fast advertising mode.

Process 1100 may include, at 1130, establishing a paired connection between the accessory device and the electronic user device. The paired connection may be a logical or virtual connection where a physical attachment or wireless connection provides the physical connection. The connection may provide a channel or link for the electronic user device, e.g., the finding application, to communicate and send messages, commands, or instructions to the accessory device that could be executed and cause the accessory device, e.g., the firmware or other processes, to perform one or more operations. The connection may include one or more hops. For example, the instructions sent by the electronic user device may go through an intermediate device, e.g., an authorized device, before reaching the accessory device.

Process 1100 may include, at 1140, causing the accessory device to operate in the findable mode. The electronic user device may send instructions to the accessory device via the established, paired connection. The instruction may cause the accessory device to operate in the findable mode, e.g., fast advertising mode.

In some instances, the accessory device may operate in the findable mode in accordance with a criterion. For example, the accessory device may operate in findable mode (e.g., fast advertising mode) based on determining the active finding session. In some examples, once the finding session is terminated, the electronic user device may instruct the accessory device to stop operating in the findable mode.

In some embodiments, establishing a paired connection between the accessory device and the electronic user device may include one or more operations. For example, the electronic user device may start a discovery scan using cryptographic information of the accessory device. The electronic user device may receive advertisement packets from different sources and may scan them based on the cryptographic information of the accessory device. The electronic user device may detect an advertisement packet of the accessory device when the cryptographic information of the electronic user device matches the information obtained from the advertisement packet.

The electronic user device may obtain the MAC address of the accessory device based on the cryptographic information. In some instances, the electronic user device may obtain the MAC address from the advertisement packet or request it from the accessory device. The electronic user device may obtain a unique identifier of the accessory device based on the MAC address. The electronic device may connect to the accessory device using the unique identifier.

### G. Multi-Device Event

When an electronic user device receives a signal (e.g., a signal that can be decoded and information can be obtained from it), the electronic user device may generate a data structure, e.g., data structure 500 in FIG. 5, and store it in the computer server. The data records containing the data structures may be downloaded by devices and may be used to determine the state of a device. The state of a device may include whether it is physically attached or wirelessly connected to another device. The state of a device may also include the battery status and whether the device is functional. The electronic user device may obtain location or connection information from the data records or locally stored data structures. For example, the electronic user device may determine the location of the device.

For example, an electronic user device may be paired with a first device. The electronic user device may initiate a finding session to locate the first device. The electronic user device may receive data records generated and stored by second, third, or other devices. The data records may be directly or indirectly related to the first device. For example, the data records may be directly related to the first device where the signals are received from the first device. The data records may indirectly relate to the first device, where the signals are received from the devices that the first device was physically attached to or wirelessly connected to.

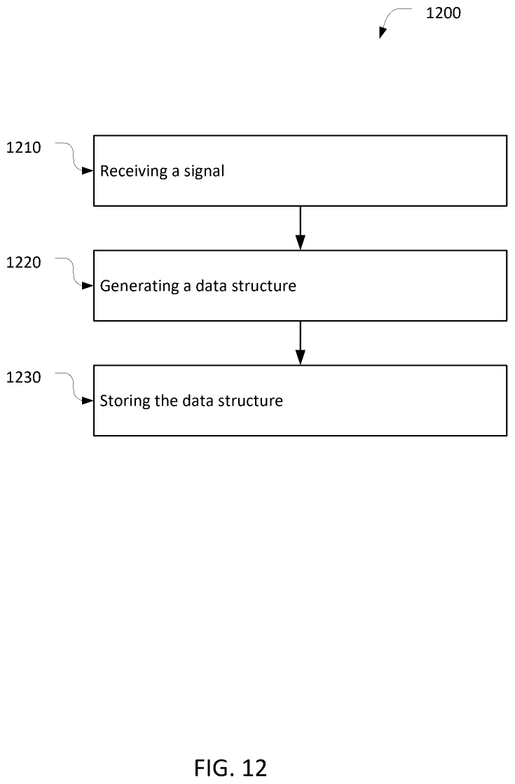

FIG. 12 illustrates a flow diagram of an example process 1200 in accordance with some embodiments. The process 1200 may be performed or implemented by an electronic user device, such as the electronic user device 106, 116, or components thereof, such as process 110 or controller 1300.

Process 1200 may include, at 1210, receiving a signal. The signal may be received by a user device (e.g., an electronic user device) from an accessory device. The electronic user device may receive one or more signals from one or more devices. Some signals may be from devices that establish a network connection with the electronic user device, e.g., physically attached or wirelessly connected to the device. Some signals may be overheard as communicated among devices, e.g., handshake signaling such as advertisement signals. The signal can characterize a location event of the accessory device. For example, upon receiving the signal the electronic user device can obtain location information for the accessory device with respect to the electronic user device, including a location of the electronic user device.

Process 1200 may include, at 1220, generating a data structure associated with the signal. The data structure may be the data structure as described in FIG. 5. The data structure can include information corresponding to the location of the user device. For example, the electronic user device can determine its location as well as a location of the accessory device with respect to the electronic user device to use as location information in the data structure.

Process 1200 may include, at 1230, storing the data structure as a data record in a computer server. The electronic user device may store the data structure generated for each signal in the computer server. In some embodiments, prior to storing the data structure in the computer server, the user device can receive an additional signal from an additional accessory device and update the data structure with additional information associated with the additional signal. For example, the electronic user device can add location information for the additional accessory device to the data structure so that the data structure includes the information corresponding to both accessory devices. In some embodiments, a separate data structure can be generated for each accessory device from which the user device receives a signal.

In some embodiments, the data structure can include source information, location information, motion context, or attachment information of the accessory device. In some embodiments, the user device can encrypt the data structure prior to storing the data structure in the computer server.

The electronic user device may receive one or more data structures stored in one or more data records. In some embodiments, the electronic user device may determine the status of an accessory device based on the one or more data structures or local information. The status of the accessory device can include an on state, an off state, a physically attached state, a wirelessly connected state, an active state, or a dormant state. The state of the accessory device can be relative to another device. For example, the data structure may indicate that a stylus is physically attached to a tablet device. In some embodiments, determining the status of the accessory device can include determining a precedence of information in the one or more data structures. Each piece of information in the data structure can be associated with a precedence value so that the user device can determine whether certain portions of the data structure are more relevant for determining a location of the accessory device. For example, if a data structure indicates that an accessory device is disconnected from one user device, but a second data structure indicates that the accessory device is physically attached to another user device, the information associated with the physical attachment to the other user device may have precedence, since the location of the attached other user device may be more accurate with respect to the accessory device.

In some embodiments, the user device can send a request to an authorized user device connected to the accessory device. The request may be based on the status of the accessory device. The request usable to by the authorized user device to place the accessory device in a findable mode. For example, the data structure may indicate that the accessory device is physically attached to the authorized user device but not currently in a findable mode. The request can instruct the authorized user device to place the accessory device in the findable mode.

### H. Examples

In the following sections, further exemplary embodiments are provided.
Example 1 includes a method including: sending a paired verification message to an accessory device, the paired verification message requesting the accessory device to verify a paired state of the accessory device with respect to an electronic user device associated with a user; and receiving a response from the accessory device the response identifying a first paired state of a plurality of paired states; depending on the first paired state, performing at least one of: requesting a pairing lock status from a computer server; determining network pairing information associated with a network pairing connection between the electronic user device and the accessory device; or initiating pairing between the accessory device and the electronic user device to pair the accessory device and the electronic user device.
Example 2 includes the method of example 1 or some other examples herein, further including: receiving a pairing lock status response from the computer server.
Example 3 includes the method of examples 1 or 2 or some other example herein, further including: determining, based on the pairing lock status response received from the computer server, that the accessory device is not paired with the electronic user device.
Example 4 includes the method of any of examples 1-3 or some other example herein, wherein the user is a first user, and the method further includes: determining, based on the pairing lock status response received from the computer server, that the accessory device is paired with a user identifier (ID) of a second user.
Example 5 includes the method of any of examples 1-4 or some other example herein, the method further including: providing a message for presentation on the electronic user device, the message indicating that the accessory device is not associated with the first user.
Example 6 includes the method of any of examples 1-5 or some other example herein, further including: receiving, from the computer server during an initial onboarding and based on device information, an encrypted message, the encrypted message indicating that the accessory device is lost or includes contact information of the second user.
Example 7 includes the method of any of examples 1-6 or some other example herein, further including: sending periodic requests to the computer server for a lost message associated with the accessory device.
Example 8 includes the method of any of examples 1-7 or some other example herein, further including: receiving, from the computer server, an encryption key associated with the second user; encrypting first location information associated with the accessory device using the encryption key; and storing the encrypted first location information of the accessory device on the computer server or a location information server.
Example 9 includes the method of any of examples 1-8 or some other example herein, wherein the first location information of the accessory device is based on second location information of the electronic user device, and the method further includes: sending, to the computer server, a consent associated with storing the encrypted first location information of the accessory device.
Example 10 includes the method of any of examples 1-9 or some other example herein, further including, prior to encrypting the first location information, receiving an indication of consent associated with storing the first location information on the computer server.
Example 11 includes the method of any of examples 1-9 or some other example herein, further including, prior to encrypting the first location information, retrieving a previous consent associated with storing the first location information to the computer server.
Example 12 includes the method of any of examples 1-11 or some other example herein, further including: connecting to the accessory device after an initial onboarding; sending periodic requests to the computer server for a lost message associated with the accessory device; receiving, from the computer server and based on the periodic requests, an indication of a lost mode associated with the accessory device; establishing an encrypted and secure link with the computer server; and receiving, from the computer server, an encrypted message that is associated with the accessory device and the second user.
Example 13 includes the method of any of examples 1-12 or some other example herein, wherein the encrypted message includes contact information associated with the second user.
Example 14 includes the method of any of examples 1-13 or some other example herein, further including: determining that the electronic user device is authorized by the user ID of the second user; and storing information associated with the accessory device to an encrypted data store, the information including connectivity information and device information of the accessory device.
Example 15 includes the method of any of examples 1-14 or some other example herein, wherein the encrypted data store is a cloud-based storage.
Example 16 includes the method of any of examples 1-15 or some other example herein, wherein: the accessory device is physically attached or wirelessly connected to the electronic user device; the connectivity information includes an indication associated with a physical attachment or a wireless connection between the accessory device and the electronic user device; and the device information identifies the electronic user device.
Example 17 includes the method of any of examples 1-16 or some other example herein, wherein the device information includes an indication of whether the accessory device is functioning.
Example 18 includes the method of any of examples 1-17 or some other example herein, wherein the connectivity information includes time information indicating a time associated with a wireless connection or a physical attachment between the accessory device and the electronic user device.
Example 19 includes the method of any of examples 1-18 or some other example herein, further including: generating location information to be stored in a location server different from the encrypted data store.
Example 20 includes the method of any of examples 1-19 or some other example herein, wherein the location information includes location information of the electronic user device connected or attached to the accessory device.
Example 21 includes the method of any of examples 1-20 or some other example herein, further including: determining, based on the pairing lock status response received from the computer server, that the accessory device is not paired with any user identifier (ID); and receiving an indication to initiate a pairing session to pair the accessory device with the electronic user device.
Example 22 includes the method of any of examples 1-21 or some other example herein, further including: sending a request to the computer server to lock the accessory device to a user identifier (ID) associated with the user, the request including device information and cryptography information; and receiving a validation based on the cryptographic information.
Example 23 includes the method of any of examples 1-22 or some other example herein, further including: storing information associated with the accessory device to an encrypted data store, the information including connectivity information and device information of the accessory device.
Example 24 includes the method of any of examples 1-23 or some other example herein, wherein the encrypted data store is a cloud-based storage.
Example 25 includes the method of any of examples 1-24 or some other example herein, wherein: the accessory device is physically attached or wirelessly connected to the electronic user device; the connectivity information includes an indication associated with a physical attachment or a wireless connection between the accessory device and the electronic user device; and the device information includes an indication of the electronic user device.
Example 26 includes the method of any of examples 1-25 or some other example herein, wherein the device information includes an indication of whether the accessory device is Example 27 includes the method of any of examples 1-26 or some other example herein, wherein the information includes time information indicating a time associated with a wireless connection or a physical attachment between the accessory device and the electronic user device.
Example 28 includes the method of any of examples 1-27 or some other example herein, further including: generating location information to be stored in a location server different from the encrypted data store.
Example 29 includes the method of any of examples 1-28 or some other example herein, wherein the location information includes location information of the electronic user device connected or attached to the accessory device.
Example 30 includes one or more non-transitory computer-readable media including computer-executable instructions that, when executed by one or more processors of a computing device, cause the computing device to perform the method of any one of examples 1-29.
Example 31 includes a system, including: a memory configured to store computer-executable instructions; and a processor configured to access the memory and execute the computer-executable instructions to at least perform the method of any one of examples 1-29.
Example 32 includes a method including: receiving, from an electronic user device and at an accessory device, a paired verification message, the paired verification message requesting the accessory device to verify a paired state of the accessory device with respect to the electronic user device; determining the paired state of the accessory device by at least determining whether the electronic user device shares a network pairing connection with the accessory device; and sharing the paired state of the accessory device with the electronic user device.
Example 33 includes the method of example 32 or some other example herein, further including: determining that the paired state is a first paired state; and in response to determining that the paired state is the first paired state: configuring the accessory device based on a fast advertising mode, and causing the accessory device to advertise a network connection signal.
Example 34 includes the method of examples 32 or 33 or some other example herein, wherein determining that the paired state is the first paired state includes: determining, based on firmware of the accessory device, that the accessory device is paired with a first user identifier (ID) associated with the electronic user device; and determining, based on the paired verification message, that the paired verification message is associated with a second user ID that is different from the first user ID.
Example 35 includes the method of any of examples 30-34 or some other example herein, wherein the network connection signal includes a medium access control (MAC) address and cryptography information associated with the first user ID.
Example 36 includes the method of any of examples 30-35 or some other example herein, further including: determining that the paired state is a second paired state; and in response to determining that the paired state is the second paired state, exchanging communications with the electronic user device to pair the accessory device with the electronic user device.
Example 37 includes one or more non-transitory computer-readable media comprising computer-executable instructions that, when executed by one or more processors of a computing device, cause the computing device to perform the method of any one of claims 30-36.
Example 38 includes a system, including: a memory configured to store computer-executable instructions; and a processor configured to access the memory and execute the computer-executable instructions to at least perform the method of any one of claims 30-36.
Example 39 includes ae method including: initiating, at an electronic user device, a finding session for finding an accessory device that is paired with the electronic user device; determining that the accessory device is not in a findable mode; establishing a paired connection between the accessory device and the electronic user device; and after establishing the paired connection and during the finding session, causing the accessory device to operate in the findable mode in accordance with a criterion.
Example 40 includes the method of example 39 or some other example herein, further including: stopping operating in the findable mode based on the criterion.
Example 41 includes the method of examples 39 or 40 or some other example herein, wherein the criterion is associated with closing of the finding session.
Example 42 includes the method of any of examples 39-41 or some other example herein, further including: extending operating in the findable mode for a duration based on the criterion.
Example 43 includes the method of any of examples 39-42 or some other example herein, wherein the criterion includes: determining that the finding session is active.
Example 44 includes the method of any of examples 39-43 or some other example herein, wherein establishing the paired connection between the accessory device and the electronic user device includes: obtaining a unique identifier of the accessory device using a previously stored medium access control (MAC) address of the accessory device; and connecting to the accessory device via a network connection based on the unique identifier.
Example 45 includes the method of any of examples 39-44 or some other example herein, wherein establishing the paired connection between the accessory device and the electronic user device includes: starting a discovery scan using cryptographic information of the accessory device; obtaining a medium access control (MAC) address of the accessory device based on the cryptographic information; obtaining a unique identifier of the accessory device based on the MAC address; and connecting to the accessory device based on the unique identifier.
Example 46 includes the method of any of examples 39-45 or some other example herein, wherein causing the accessory device to operate in the findable mode includes: sending a signal to the accessory device to configure the accessory device to operate in a fast advertising mode.
Example 47 includes the method of any of examples 39-46 or some other example herein, further including: accessing a data record associated with the accessory device; and using the data record to determine a location of the accessory device with respect to a different electronic device.
Example 48 includes the method of any of examples 39-47 or some other example herein, wherein the data record comprises a multi-device sync record that is associated with the accessory device via a unique user identifier.
Example 49 includes the method of any of examples 39-48 or some other example herein, wherein initiating the finding session for finding the accessory device includes: selecting, at a user interface of the electronic user device, the accessory device from a list of findable devices; and selecting, at the user interface, a finding user interface element.
Example 50 includes the method of any of examples 39-49 or some other example herein, further including: receiving one or more data structures from a computer server; and determining a status of the accessory device based on the one or more data structures.
Example 51 includes the method of any of examples 39-50 or some other example herein, wherein a data structure of the one or more data structures includes source information, location information, motion context, or attachment information.
Example 52 includes the method of any of examples 39-51 or some other example herein, wherein the status indicates whether the accessory device is physically attached or wirelessly connected to another device.
Example 53 includes one or more non-transitory computer-readable media including computer-executable instructions that, when executed by one or more processors of a computing device, cause the computing device to perform the method of any one of claims 39-52.
Example 54 includes a system, including: a memory configured to store computer-executable instructions; and a processor configured to access the memory and execute the computer-executable instructions to at least perform the method of any one of claims 37-52.
Example 55 includes a method including: receiving, at a user device, a signal from an accessory device, the signal characterizing a location event for the accessory device; generating, by the user device, a data structure associated with the signal, the data structure comprising information corresponding to a location of the user device; and storing the data structure in a computer server.
Example 56 includes the method example 55 or some other example, wherein the data structure includes source information, location information, motion context, or attachment information of the accessory device.
Example 57 includes the method of example 55 or 56 or some other example, further including, prior to storing the data structure in the computer server, receiving, by the user device, an additional signal from an additional accessory device; and updating, by the user device, the data structure with additional information associated with the additional signal.
Example 58 includes the method of examples 55-57 or some other example, further including receiving one or more data structures from the computer server; and determining a status of another accessory device based on the one or more data structures.
Example 59 includes the method of examples 55-58 or some other example, wherein the status of the another accessory device comprises an on state, an off state, a physically attached state, a wirelessly connected state, an active state, or a dormant state.
Example 60 includes the method of examples 55-59 or some other example, wherein determining the status of the another accessory device comprises determining a precedence of information in the one or more data structures.
Example 61 includes the method of examples 55-60 or some other example, further including, based on the status of the another accessory device, sending a request to an authorized user device connected to the another accessory device, the request usable to by the authorized user device to place the another accessory device in a findable mode.
Example 62 includes the method of examples 55-61 or some other example, further including, encrypting the data structure prior to storing the data structure in the computer server.
Example 63 includes one or more non-transitory computer-readable media including computer-executable instructions that, when executed by one or more processors of a computing device, cause the computing device to perform the method of any one of claims 55-62.
Example 64 includes a system, including: a memory configured to store computer-executable instructions; and a processor configured to access the memory and execute the computer-executable instructions to at least perform the method of any one of claims 55-62.

Another example may include an apparatus comprising means to perform one or more elements of a method described in or related to any of examples 1-64, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-64, or any other method or process described herein.

Another example may include an apparatus comprising logic, modules, or circuitry to perform one or more elements of a method described in or related to any of examples 1-64, or any other method or process described herein.

Another example may include a method, technique, or process as described in or related to any of examples 1-64, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-64, or portions thereof.

Another example may include a signal as described in or related to any of examples 1-64, or portions or parts thereof.

Another example may include a datagram, information element, packet, frame, segment, PDU, or message as described in or related to any of examples 1-64, or portions or parts thereof, or otherwise described in the present disclosure.

Another example may include a signal encoded with data as described in or related to any of examples 1-64, or portions or parts thereof, or otherwise described in the present disclosure.

Another example may include a signal encoded with a datagram, IE, packet, frame, segment, PDU, or message as described in or related to any of examples 1-64, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-64, or portions thereof.

Another example may include a computer program comprising instructions, wherein execution of the program by a processing element is to cause the processing element to carry out the method, techniques, or process as described in or related to any of examples 1-64, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

### V. Example Device

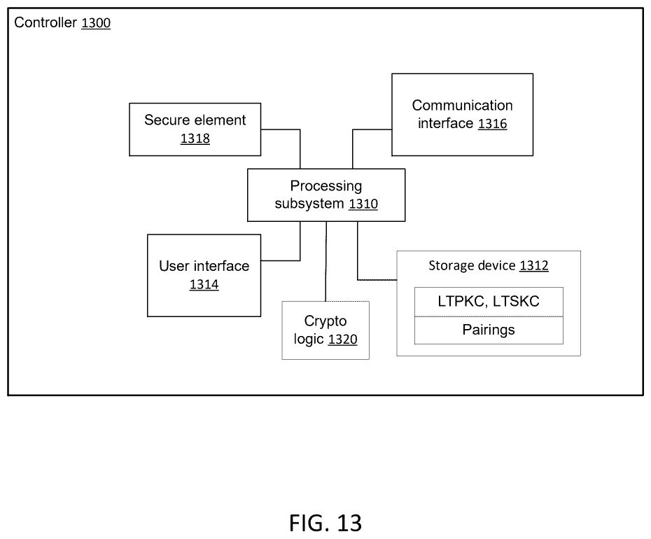

FIG. 13 is a block diagram of an example device according to the embodiments of the present disclosure. FIG. 13 is a block diagram of a controller 1300 according to some embodiments. Controller 1300 may be included in a user device, a controller device, a resident device, a hub device, an accessory device, a vehicle entertainment center, a wearable device (e.g., smartwatch, headset, etc.), or any other suitable electronic device. Controller 1300 may implement any or all of the controller functions, behaviors, and capabilities described herein and other functions, behaviors, and capabilities not expressly described.

For example, the application of the home automation system may be executed on the processing subsystem 1310, which may cause the communication interface 1316 to use the protocol and technology associated with the LAN for transmissions related to updating a primary location.

Controller 1300 may include processing subsystem 1310, storage device 1312, user interface 1314, communication interface 1316, secure element 1318, and cryptographic logic module 1320. Controller 1300 may also include other components (not explicitly shown), such as a battery, power controllers, and other components operable to provide various enhanced capabilities. In various embodiments, controller 1300 may be implemented in a desktop computer, laptop computer, tablet computer, smartphone, wearable computing device, or other systems having any desired form factor. Further, as noted above, controller 1300 may be implemented partly in a base station and partly in a mobile unit that communicates with the base station and provides a user interface.

Storage device 1312 may be implemented, e.g., using disk, flash memory, or any other non-transitory storage medium, or a combination of media, and may include volatile or nonvolatile media. In some embodiments, storage device 1312 may store one or more application or operating system programs to be executed by processing subsystem 1310, including computer-executable instructions or programs to implement any or all operations described herein as being performed by a controller. The storage device 1312 may include a non-transitory computer-readable medium to store computer-executable instructions or programs. The processing subsystem 1310 may include one or more processors configured to access the memory storage 1312. For example, storage device 1312 may store a uniform controller application that may read an accessory definition record and generate a graphical user interface for controlling the accessory based on the information therein. In some embodiments, portions (or all) of the controller functionality described herein may be implemented in operating system programs rather than applications. In some embodiments, storage device 1312 may also store apps designed for specific accessories or specific categories of accessories (e.g., an IP camera app to manage an IP camera accessory or a security app to interact with door lock accessories).

User interface 1314 may include input devices such as a touchpad, touch screen, scroll wheel, click wheel, dial, button, switch, keypad, microphone, or the like, as well as output devices such as a video screen, indicator lights, speakers, headphone jacks, or the like, together with supporting electronics (e.g., digital to analog or analog to digital converters, signal processors, or the like). A user may operate input devices of user interface 1314 to invoke the functionality of controller 1300 and may view or hear output from controller 1300 via output devices of user interface 1314.

Processing subsystem 1310 may be implemented as one or more integrated circuits, e.g., one or more single-core or multi-core microprocessors or microcontrollers, examples of which are known in the art. In operation, processing system 1310 may control the operation of controller 1300. In various embodiments, processing subsystem 1310 may execute programs in response to program code and maintain multiple concurrently executing programs or processes. At any given time, some or all of the program code to be executed may be resident in processing subsystem 1310 or in storage media such as storage device 1312.

Through suitable programming, processing subsystem 1310 may provide various functionality for controller 1300. For example, in some embodiments, processing subsystem 1310 may implement various processes (or portions thereof) described above as being implemented by a controller. Processing subsystem 1310 may also execute other programs to control other functions of controller 1300, including programs that may be stored in storage device 1312. In some embodiments, these programs may interact with an accessory, e.g., by generating messages to be sent to the accessory or receiving messages from the accessory. Such messages may conform to a uniform accessory protocol as described above.

Communication interface 1316 may provide voice or data communication capability for controller 1300. In some embodiments, communication interface 1316 may include radio frequency (RF) transceiver components for accessing wireless voice or data networks (e.g., using cellular telephone technology, data network technology such as 5G, 4G/LTE, Wi-Fi® (IEEE 802.11 family standards), or other mobile communication technologies, or any combination thereof), components for short-range wireless communication (e.g., using Bluetooth® or Bluetooth® LE standards, NFC, etc.), or other components. In some embodiments, communication interface 1316 may provide wired network connectivity (e.g., Ethernet) in addition to or instead of a wireless interface. Communication interface 1316 may be implemented using a combination of hardware (e.g., driver circuits, antennas, modulators/demodulators, encoders/decoders, and other analog or digital signal processing circuits) and software components. In some embodiments, communication interface 1316 may support multiple communication channels concurrently, using the same transport or different transports.

The secure element 1318 may be an integrated circuit or the like that may securely store cryptographic information for controller 1300. Examples of information that may be stored within the secure element 1318 include the controller's long-term public and secret keys (LTPKC, LTSKC as described above) and a list of paired accessories (e.g., a lookup table that maps accessory ID to accessory long-term public key LTPKA for accessories that have completed a pair setup or pair add process as described above).

In some embodiments, cryptographic operations may be implemented in a cryptographic logic module 1320 that communicates with the secure element 1318. Physically, cryptographic logic module 1320 may be implemented in the same integrated circuit with the secure element 1318 or a different integrated circuit (e.g., a processor in processing subsystem 1310) as desired. Cryptographic logic module 1320 may include various logic circuits (fixed or programmable as desired) that implement or support cryptographic operations of controller 1300, including any or all cryptographic operations described above. The secure element 1318 or cryptographic logic module 1320 may appear as a “black box” to the rest of controller 1300. Thus, for instance, communication interface 1316 may receive a message in an encrypted form that it cannot decrypt and may simply deliver the message to processing subsystem 1310. Processing subsystem 1310 may also be unable to decrypt the message, but it may recognize the message as encrypted and deliver it to cryptographic logic module 1320. Cryptographic logic module 1320 may decrypt the message (e.g., using information extracted from the secure element 1318) and determine what information to return to processing subsystem 1310. As a result, certain information may be available only within the secure element 1318 and cryptographic logic module 1320. If secure element 1318 and cryptographic logic module 1320 are implemented on a single integrated circuit that executes code only from a secure internal repository, this may make extracting the information extremely difficult, providing a high degree of security. Other implementations are also possible.

The various examples can further be implemented in a wide variety of operating environments, which in some cases can include one or more user computers, computing devices, or processing devices that can be used to operate any of a number of applications. User or client devices can include any of a number of general-purpose personal computers, such as desktop or laptop computers running a standard operating system, as well as cellular, wireless, and handheld user devices running mobile software and capable of supporting a number of networking and messaging protocols. Such a system can also include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art of supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media, as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices, such as RAM or ROM, as well as removable media devices, memory cards, flashcards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used, and/or particular elements might be implemented in hardware, software (including portable software, such as applets), or both. Further, connection to other computing devices, such as network input/output devices, may be employed.

Non-transitory storage media and computer-readable media for containing code, or portions of code, can include any appropriate media known or used in the art, including storage media, such as, but not limited to, volatile and nonvolatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein is merely intended to serve as a shorthand method of referring individually to each separate value falling within the range unless otherwise indicated herein, and each separate value is incorporated into the specification as if it were individually recited herein. All methods described herein can be performed in any suitable order unless otherwise indicated herein or otherwise clearly contradicted by context. The use of any and all examples or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present. The phrase “based on A” means “based at least in part on A,” for example, it could be “based solely on A,” or it could be “based in part on A.”

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

Flow diagrams, as illustrated herein, provide examples of sequences of various process actions. The flow diagrams can indicate operations to be executed by a software or firmware routine and physical operations. A flow diagram can illustrate an example of the implementation of states of a finite state machine (FSM), which can be implemented in hardware or software. Although shown in a particular sequence or order, the order of the actions can be modified unless otherwise specified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, or data. The content can be directly executable (“object” or “executable” form), source code, or difference code (“delta” or “patch” code). The software content of what is described herein can be provided via an article of manufacture with the content stored thereon or via a method of operating a communication interface to send data via the communication interface. A machine-readable storage medium can cause a machine to perform the functions or operations described and includes any mechanism that stores information in a form accessible by a machine (e.g., computing device, electronic system, etc.), such as recordable/non-recordable media (e.g., read-only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters or sending signals to prepare the communication interface to provide a data signal describing the software content. The communication interface can be accessed via one or more commands or signals sent to the communication interface.

The detailed description refers to the accompanying drawings. The same reference numbers may be used in different drawings to identify the same or similar elements. In the above description, for purposes of explanation and not limitation, specific details are set forth, such as particular structures, architectures, interfaces, or techniques, to provide a thorough understanding of the various aspects of some embodiments. However, it will be apparent to those skilled in the art that they have the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail.

Various components described herein can be a means for performing the operations or functions described. Each component herein includes software, hardware, or a combination. The components can be implemented as software modules, hardware modules, special-purpose hardware (e.g., application-specific hardware, application-specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative and not restrictive sense. The scope of the invention should be measured solely by reference to the claims that follow.

Although the aspects above have been described in considerable detail, numerous variations and modifications will become apparent to those skilled in the art once the above disclosure is fully appreciated. Accordingly, the following claims are intended to be interpreted to embrace all such variations and modifications.

### VI. Privacy

As described above, one aspect of the present technology is the gathering and use of data relevant to a user's location and associated devices. The present disclosure contemplates that, in some instances, this gathered data may include personally identifiable information (PII) data that uniquely identifies or can be used to contact or locate a specific person. Such personal information data can include demographic data, location-based data, telephone numbers, email addresses, Twitter IDs, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, personal information data can be used to provide enhancements to a user's experience with mapping services. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after the users' informed consent is received. Additionally, such entities should consider taking any steps needed to safeguard and secure access to such personal information data and ensure that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of updating the home location of a home automation system, the present technology can be configured to allow users to select “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way that minimizes risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers the use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer-implemented method, comprising:
sending a paired verification message to an accessory device, the paired verification message requesting the accessory device to verify a paired state of the accessory device with respect to an electronic user device associated with a first user; and
receiving a response from the accessory device, the response identifying a first paired state of a plurality of paired states;
based in part on the first paired state, requesting a pairing lock status from a computer server;
receiving a pairing lock status response from the computer server; and
determining, based on the pairing lock status response received from the computer server, that the accessory device is paired with a user identifier (ID) of a second user.

2. The method of claim 1, further comprising:
providing a message for presentation on the electronic user device, the message indicating that the accessory device is not associated with the first user.

3. The method of claim 1, further comprising:
receiving, from the computer server during an initial onboarding and based on device information, an encrypted message, the encrypted message indicating that the accessory device is lost or includes contact information of the second user.

4. The method of claim 1, further comprising:
sending periodic requests to the computer server for a lost message associated with the accessory device.

5. The method of claim 1, further comprising:
receiving, from the computer server, an encryption key associated with the second user;
encrypting first location information associated with the accessory device using the encryption key; and
storing the encrypted first location information of the accessory device on the computer server or a location information server.

6. The method of claim 5, wherein the first location information of the accessory device is based on second location information of the electronic user device, and the method further comprises:
sending, to the computer server, a consent associated with storing the encrypted first location information of the accessory device.

7. The method of claim 5, further comprising:
prior to encrypting the first location information, receiving an indication of consent associated with storing the first location information on the computer server.

8. The method of claim 5, further comprising:
prior to encrypting the first location information, retrieving a previous consent associated with storing the first location information to the computer server.

9. The method of claim 1, further comprising:
connecting to the accessory device after an initial onboarding;
sending periodic requests to the computer server for a lost message associated with the accessory device;
receiving, from the computer server and based on the periodic requests, an indication of a lost mode associated with the accessory device;
establishing an encrypted and secure link with the computer server; and
receiving, from the computer server, an encrypted message that is associated with the accessory device and the second user.

10. The method of claim 9, wherein the encrypted message includes contact information associated with the second user.

11. A system, comprising:
a memory configured to store computer-executable instructions; and
a processor configured to access the memory and execute the computer-executable instructions to at least:
send a paired verification message to an accessory device, the paired verification message requesting the accessory device to verify a paired state of the accessory device with respect to an electronic user device associated with a first user; and
receive a response from the accessory device, the response identifying a first paired state of a plurality of paired states;
based in part on the first paired state, request a pairing lock status from a computer server;
receive a pairing lock status response from the computer server; and
determine, based on the pairing lock status response received from the computer server, that the accessory device is paired with a user identifier (ID) of a second user.

12. The system of claim 11, wherein the memory is configured to store additional computer-executable instructions that, when executed by the processor, cause the processor to further:
receive, from the computer server during an initial onboarding and based on device information, an encrypted message, the encrypted message indicating that the accessory device is lost or includes contact information of the second user.

13. The system of claim 11, wherein the memory is configured to store additional computer-executable instructions that, when executed by the processor, cause the processor to further:
receive, from the computer server, an encryption key associated with the second user;
encrypt first location information associated with the accessory device using the encryption key; and
store the encrypted first location information of the accessory device on the computer server or a location information server.

14. The system of claim 11, wherein the memory is configured to store additional computer-executable instructions that, when executed by the processor, cause the processor to further:
connect to the accessory device after an initial onboarding;
send periodic requests to the computer server for a lost message associated with the accessory device;
receive, from the computer server and based on the periodic requests, an indication of a lost mode associated with the accessory device;
establish an encrypted and secure link with the computer server; and
receive, from the computer server, an encrypted message that is associated with the accessory device and the second user.

15. The system of claim 14, wherein the encrypted message includes contact information associated with the second user.

16. One or more non-transitory computer-readable media comprising computer-executable instructions that, when executed by one or more processors of a computing device, cause the computing device to at least:
send a paired verification message to an accessory device, the paired verification message requesting the accessory device to verify a paired state of the accessory device with respect to an electronic user device associated with a first user; and
receive a response from the accessory device, the response identifying a first paired state of a plurality of paired states;
based in part on the first paired state, request a pairing lock status from a computer server;
receive a pairing lock status response from the computer server; and
determine, based on the pairing lock status response received from the computer server, that the accessory device is paired with a user identifier (ID) of a second user.

17. The one or more non-transitory computer-readable media of claim 16, comprising additional computer-executable instructions that, when executed by the one or more processors, cause the computing device to further:
receive, from the computer server, an encryption key associated with the second user;
encrypt first location information associated with the accessory device using the encryption key; and
store the encrypted first location information of the accessory device on the computer server or a location information server.

18. The one or more non-transitory computer-readable media of claim 17,
wherein the first location information of the accessory device is based on second location information of the computing device, and wherein the one or more non-transitory computer-readable media comprise additional computer-executable instructions that, when executed by the one or more processors, cause the computing device to further:
send, to the computer server, a consent associated with storing the encrypted first location information of the accessory device.

19. The one or more non-transitory computer-readable media of claim 17, comprising additional computer-executable instructions that, when executed by the one or more processors, cause the computing device to further:
prior to encrypting the first location information, receiving an indication of consent associated with storing the first location information on the computer server.

20. The one or more non-transitory computer-readable media of claim 17, comprising additional computer-executable instructions that, when executed by the one or more processors, cause the computing device to further:
prior to encrypting the first location information, retrieving a previous consent associated with storing the first location information to the computer server.
